(19) United States
(12) Patent Application Publication
(10) Pub. No.: US 2025/0212052 A1
(43) Pub. Date: Jun. 26, 2025

(54) REVERSE SIGNALING OF CONGESTION IN LOW LATENCY, LOW LOSS, AND SCALABLE THROUGHPUT (L4S) DATA FLOWS

(71) Applicant: Cisco Technology, Inc., San Jose, CA (US)

(72) Inventors: Binita Gupta, San Diego, CA (US); Juan Carlos Zuniga, Montreal (CA); Jerome Henry, Pittsboro, NC (US)

(21) Appl. No.: 18/985,000

(22) Filed: Dec. 17, 2024

Related U.S. Application Data
(60) Provisional application No. 63/633,500, filed on Apr. 12, 2024.
(60) Provisional application No. 63/614,899, filed on Dec. 26, 2023.

(51) Int. Cl. H04W 28/02; H04L 47/11; H04L 47/31

(52) U.S. Cl. CPC H04W 28/0284; H04L 47/11; H04L 47/31

(57) ABSTRACT

Devices and methods for reverse signaling of congestion in Low Latency, Low Loss, and Scalable throughput (L4S) data flows are provided. A device receives a first L4S data flow including first data packets, from a first direction, and detects a congestion associated with the first L4S data flow. The device identifies a second LAS data flow, including second data packets, from a second direction reverse to the first direction, associated with the first LAS data flow. The device marks one or more of the second data packets with a congestion indicator indicative of the congestion associated with the first L4S data flow. The congestion indicator provides a fast congestion notification associated with the LAS data flow from one direction by utilizing the LAS data flow from the reverse direction, to facilitate a fast response to the congestion and a reduction of congestion-related packet drops at the device.

### CROSS-REFERENCE TO RELATED APPLICATIONS

This application claims benefit of and priority to U.S. Provisional Application No. 63/614,899, filed Dec. 26, 2023; and U.S. 63/633,500, filed Apr. 12, 2024, wherein the entirety of each are incorporated herein by reference.

### FIELD

The present disclosure relates to communication networks. More particularly, the present disclosure relates to reverse signaling of congestion in Low Latency, Low Loss, and Scalable throughput (L4S) data flows.

### BACKGROUND

Wireless communication networks involve communication between multiple interconnected devices. For real-time or near-real-time applications, such as streaming video and multiplayer gaming, minimizing latency helps in maintaining a seamless user experience. For such applications, Low Latency, Low Loss, and Scalable throughput (LAS) may provide low queuing latency, low congestion loss, and scalable throughput control. LAS may focus on minimizing time spent by data packets in queues, thereby reducing overall latency experienced by the applications. L4S may also achieve low congestion loss based on utilization of an Explicit Congestion Notification (ECN). Further, LAS may provide a scalable throughput, thereby allowing the wireless communication networks to adapt to varying levels of demand from the devices.

In conventional systems, for implementing LAS, a dual queue architecture may be utilized. In the dual queue architecture, LAS traffic may be maintained in a separate shallow queue. Some conventional systems may also utilize a conditional priority scheduler to assign a higher priority to the L4S traffic. In some conventional systems, LAS may assume presence of a scalable congestion control mechanism at a source device that can maintain a consistently low average time between congestion signals as data flow rate scales. L4S may also require use of a packet identifier at an Internet Protocol (IP) layer to facilitate ECN signaling. However, in the conventional systems, there may be multiple delays associated with the ECN signaling. In the conventional systems, ECN-marked data packets may be queued and a congestion notification may be generated when the data packets are served. As a result, delays may occur due to one or more unserved data packets in the queue.

Further, the delays may also result from longer round-trip times between the source device and a destination device. Typically, the destination device may initiate ECN signaling which may be provided to the source device. However, the congestion may also occur at one or more intermediate devices, such as network devices, in a communication path between the source device and the destination device. In that case, the ECN signaling may be relayed through multiple devices before the source device or the destination device receives the congestion notification, thereby causing additional delay, which is undesirable.

### SUMMARY OF THE DISCLOSURE

Devices and methods for reverse signaling of congestion in Low Latency, Low Loss, and Scalable throughput (LAS) data flows in accordance with embodiments of the disclosure are described herein. In many embodiments, a device comprises a processor, a memory communicatively coupled to the processor, and a congestion notification logic. The congestion notification logic is configured to receive, from a network device, a downstream L4S data flow comprising a plurality of downstream data packets, detect a congestion associated with the downstream L4S data flow, identify an upstream L4S data flow, comprising a plurality of upstream data packets, associated with the downstream LAS data flow, and mark one or more upstream data packets of the plurality of upstream data packets with a congestion indicator.

In a number of embodiments, the congestion indicator is indicative of the congestion associated with the downstream L4S data flow.

In a variety of embodiments, the downstream LAS data flow is indicative of a first source address associated with the network device and a first destination address associated with a wireless device.

In various embodiments, identifying the upstream L4S data flow that is associated with the downstream LAS data flow comprises receiving one or more upstream LAS data flows from the wireless device and determining that the upstream LAS data flow of the one or more upstream L4S data flows is associated with a second source address associated with the wireless device and a second destination address associated with the network device.

In more embodiments, the congestion notification logic is further configured to transmit the one or more upstream data packets marked with the congestion indicator to the network device.

In additional embodiments, the congestion indicator is marked in one of a Layer 3 header or a higher layer header than the Layer 3 header of each of the one or more upstream data packets to indicate the congestion in a downstream direction.

In one or more embodiments, the congestion indicator corresponds to one of: one or more bits in an Internet Protocol (IP) Option field of an IP version 4 (IPv4) header, one or more bits in a Flags field in the IPv4 header, one or more bits in an Extension header in an IP version 6 (IPv6) header, or a specific value in a Differentiated Services Code Point (DSCP) field in an IP header.

In further embodiments, detecting the congestion associated with the downstream LAS data flow comprises storing one or more downstream data packets of the plurality of downstream data packets in a queue; determining a count of the one or more downstream data packets in the queue; and comparing the count of the one or more downstream data packets with a threshold count, wherein the congestion is detected based on the count of the one or more downstream data packets exceeding the threshold count.

In still more embodiments, a device comprises a processor, a memory communicatively coupled to the processor, and a congestion notification logic configured to receive, from a wireless device, an upstream Low Latency, Low Loss, and Scalable throughput (L4S) data flow comprising a plurality of upstream data packets; detect a congestion associated with the upstream LAS data flow; generate a congestion signaling request configured to indicate the detected congestion; and transmit a congestion indicator to the wireless device based on the generated congestion signaling request.

In still further embodiments, the congestion indicator is indicative of the congestion associated with the upstream L4S data flow.

In some more embodiments, transmitting the congestion indicator comprises generating a Media Access Control (MAC) Protocol Data Unit (MPDU) comprising a congestion indication control field in a MAC header and transmitting the MPDU to the wireless device.

In yet various embodiments, the congestion indication control field comprises a value indicative of the congestion associated with the upstream L4S data flow.

In yet more embodiments, the congestion signaling request comprises at least one of: a priority of one or more upstream data packets of the plurality of upstream data packets associated with the congestion in the upstream LAS data flow, an identifier of the upstream L4S data flow, an indication of a direction of the detected congestion; a count of the one or more upstream data packets, a percentage of upstream data packets of the upstream LAS data flow experiencing the detected congestion, or a probability of the congestion being experienced by the one or more upstream data packets.

In still yet more embodiments, the congestion indicator is transmitted to the wireless device in at least one of a downstream data packet having the wireless device as a destination, a quality of service null frame, or a management frame.

In many further embodiments, the management frame comprises at least one of: a priority of one or more upstream data packets of the plurality of upstream data packets associated with the congestion in the upstream LAS data flow, an identifier of the upstream L4S data flow, an indication of a direction of the detected congestion, a count of the one or more upstream data packets, a percentage of upstream LAS data packets of the upstream LAS data flow experiencing the detected congestion, or a probability of the congestion being experienced by the one or more upstream data packets.

In many additional embodiments, detecting the congestion associated with the upstream LAS data flow comprises storing one or more upstream data packets of the plurality of upstream data packets in a queue; determining a count of the one or more upstream data packets in the queue; and comparing the count of the one or more upstream data packets with a threshold count, wherein the congestion is detected based on the count of the one or more upstream data packets exceeding the threshold count.

In still yet further embodiments, the upstream LAS data flow is indicative of a source address associated with the wireless device and a destination address associated with a network device.

In still yet additional embodiments, a device comprises a processor, a memory communicatively coupled to the processor, and a congestion notification logic configured to receive, from a wireless device, one or more upstream Low Latency, Low Loss, and Scalable throughput (L4S) data flows, detect a congestion associated with an upstream LAS data flow of the one or more upstream L4S data flows, identify a downstream L4S data flow, comprising a plurality of downstream data packets, associated with the upstream LAS data flow, and mark one or more downstream data packets of the plurality of downstream data packets with a congestion indicator.

In several embodiments, identifying the downstream L4S data flow associated with the upstream LAS data flow comprises receiving the downstream LAS data flow from the network device and determining that the downstream LAS data flow is associated with a source address associated with the network device and a destination address associated with the wireless device.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic diagram of a wireless communication network in accordance with various embodiments of the disclosure;

FIG. 2 is a block diagram of a system illustrating a reverse signaling of downstream congestion in a wireless communication network in accordance with various embodiments of the disclosure;

FIG. 3 is a block diagram of a system illustrating a reverse signaling of upstream congestion in a wireless communication network in accordance with various embodiments of the disclosure;

FIG. 4 is a block diagram of a system illustrating a reverse signaling of upstream congestion in a wireless communication network in accordance with various embodiments of the disclosure;

FIG. 5 is a schematic illustration of a control information field format for reverse signaling of congestion in accordance with various embodiments of the disclosure;

FIG. 6 is a schematic illustration of a format of a header for reverse signaling of congestion in accordance with various embodiments of the disclosure;

FIG. 7 is a flowchart depicting a process for reverse signaling of downstream congestion in accordance with various embodiments of the disclosure;

FIG. 8 is a flowchart depicting a process for reverse signaling of downstream congestion in accordance with various embodiments of the disclosure;

FIG. 9 is a flowchart depicting a process for reverse signaling of upstream congestion in accordance with various embodiments of the disclosure;

FIG. 10 is a flowchart depicting a process for reverse signaling of upstream congestion in accordance with various embodiments of the disclosure;

FIG. 11 is a flowchart depicting a process for reverse signaling of upstream congestion in accordance with various embodiments of the disclosure; and

FIG. 12 is a conceptual block diagram of a device suitable for configuration with a congestion notification logic for implementing the functionality and various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DETAILED DESCRIPTION

In response to the issues described above, devices and methods are discussed herein for reverse signaling of congestion in Low Latency, Low Loss, and Scalable throughput (L4S) data flows. Congestion in a network may relate to a heavy utilization of the network leading to delays and/or packet losses. To signal the congestion, a receiver that is made aware of the congestion in the network (for example, either by detecting the congestion itself or being informed of the congestion by a network device such as an access point), may transmit feedback to a sender to make the sender aware of the congestion. When the sender receives the feedback that indicates the congestion, the sender may, for example, reduce data transmission rate to at least partially alleviate the congestion in the network. LAS may refer to an architecture and a protocol that provide low queuing latency, low congestion loss, and scalable throughput control for applications such as streaming video, multiplayer gaming, and other real-time and near-real-time applications. LAS may rely on an Explicit Congestion Notification (ECN) to provide high throughput and low latency for Internet Protocol (IP) traffic. ECN may refer to an extension to the IP and to the Transmission Control Protocol (TCP), that provides an end-to-end notification of the congestion in the network without dropping data packets. The dropping of the data packets by the TCP/IP may cause a retransmission delay that introduces latency which may be undesirable for low latency, high throughput applications in a cloud environment and other environments. Each retransmission may be time consuming and can cause an application to reduce the responsiveness to the congestion.

Unlike TCP/IP networks that signal congestion by dropping data packets, when ECN is successfully negotiated, an ECN-aware device may set a mark in an IP header of the data packet instead of dropping the data packet to signal an impending congestion. The receiver of the data packet may echo the congestion indication to the sender, which may reduce data transmission rate as if the sender detected a dropped data packet. In many embodiments, the devices and methods discussed herein provide a fast congestion notification for an LAS data flow in one direction by utilizing another L4S data flow in a reverse direction. Thus, facilitating a fast response to the congestion and a reduction of congestion-related packet drops at a device, for example, an access point. The devices and methods discussed herein may signal L4S congestion, experienced at the access point, in the reverse direction for upstream and downstream LAS data flows. This may allow faster LAS congestion signaling leading to a faster response to the congestion, and hence a reduction of congestion-related packet drops at the access point.

The devices and methods discussed herein provide a congestion notification for LAS data flows with reduced round-trip times and delays. In a number of embodiments, an access point may be in communication with a plurality of wireless devices in a wireless communication network. Examples of the wireless devices can include electronic devices, such as, but not limited to, laptops, smartphones, computers, tablets, or the like. The wireless communication network may utilize, for example, 6 gigahertz (GHz), 5 GHz, or 2.4 GHz frequency bands, or millimeter wave (mmWave) frequencies. The access point can be wirelessly connected to the wireless devices by way of the IEEE 802.11 wireless communication technology, for example, Wi-Fi® of the Wi-Fi Alliance Corporation. The wireless devices can be LAS-enabled wireless devices. The LAS data flows may be utilized to improve performance of real-time or near-real-time applications in the LAS-enabled wireless devices. Examples of the real-time or near-real-time applications can include interactive web, web services, voice, conversational video, interactive video, interactive remote presence, instant messaging, online and cloud-rendered gaming, remote desktop, cloud-based applications, cloud-rendered virtual reality or augmented reality, and video-assisted remote control of machinery and industrial processes. The access point can also be in communication with one or more network devices, such as, but not limited to, servers, routers, switches, or databases by way of wired and/or wireless communication networks.

In a variety of embodiments, the access point can receive multiple data flows. The data flows may comprise one or more data packets. Typically, the data packets are enqueued or buffered in a queue before servicing or transmission of the data packets. A queue may refer to a buffer where data packets are temporarily stored before being transmitted. As the data packets arrive faster than they can be processed or transmitted, the data packets may accumulate in the queue. Delays can occur in the transmission of the data packets due to buffer bloat or when a sender transmits the data flows at a higher bit rate than what is supported by a communication network. Some data flows may utilize TCP which can utilize acknowledgment data packets to signal successful reception of the data packets. The acknowledgment data packets, in conjunction with a congestion window, may be utilized to detect a bottleneck. For the real-time or near-real-time applications, some data flows may utilize the ECN. The ECN may utilize one or more bits in a header of a data packet to indicate congestion. In various embodiments, for example, the one or more bits may be two least significant bits of a Traffic Class (TCLAS) field in an IP header. An access point may, instead of dropping the data packets, mark the data packets with a Congestion Experienced (CE) value in an ECN field of the IP header of the data packets. The L4S data flows can enhance the ECN by utilizing the one or more bits to signal that the data flows support L4S. This enhanced ECN may provide a scalable congestion control technique in which the congestion window or transmission rate may be reduced proportionally based on the data packets marked with the CE value.

In more embodiments, for example, the LAS data flows may be the data flows that indicate the LAS capability in the one or more bits, that is, the ECN bits, in the header of the data packets. In additional embodiments, for example, the L4S data flows can be the data flows that are indicative of real-time, near-real-time, or latency-sensitive data flows. In further embodiments, for example, the LAS data flows can be the data flows that can support one or more scalable congestion control techniques such as the ECN. In still more embodiments, for example, the LAS data flows can be the data flows that can support early congestion detection and notification. In still further embodiments, for example, the L4S data flows may be the data flows in which the sender may continually or dynamically adapt the transmission rate based on the congestion.

L4S may allow isolation of network traffic in separate queues. In still additional embodiments, the access point can enqueue the data flows, including L4S data flows and non-LAS data flows in both: upstream and downstream. “Upstream” may refer to a direction of a data flow from a station (herein referred to as an “STA”), for example, a client device, to a remote system, for example, a destination server. “Downstream” may refer to a direction of data flow from the remote system to the STA. To enqueue the data flows, the access point may utilize a dual queue system. The access point may also utilize an Active Queue Management (AQM) system to actively detect and notify a congestion associated with the L4S data flows. In some more embodiments, a queuing scheme can be implemented in firmware of the access point. The firmware may implement the queuing scheme by utilizing hardware such as, but not limited to, Wi-Fi® chipsets or wireless network cards. In yet various embodiments, the queuing scheme can be implemented in an operating system of the access point. The operating system may provide flexibility in managing the queuing scheme, which may include, for example, dynamically changing threshold data packets for different queues, dynamically selecting and scheduling data packets for transmission, assigning and/or modifying priorities for the queues, etc.

Conventionally, when there are L4S data flows in an upstream direction, that is, from the STA to the destination server, and when the access point experiences congestion in its LAS egress queue, as an LAS network node, the access point may mark the ECN bits in upstream data packets of the LAS data flows to indicate the congestion. For example, the access point may set ECN to 11 to indicate Congestion Experienced (CE) in the upstream data packets. When the destination server receives the upstream data packets marked with the ECN bits, the destination server may indicate to an application on the STA to reduce data transmission rate. For example, in response to receiving the upstream data packets marked with the ECN bits set to 11, the destination server may transmit a TCP/Quick User Datagram Protocol (UDP) Internet Connections (QUIC) layer congestion signal back to the STA for the STA to scale down the data transmission rate. However, there is a round-trip delay associated with transmitting the congestion notification to the STA if the access point experiences the congestion in its LAS egress queue for upstream traffic. The round trip may involve a transmission from the access point to the destination server and a transmission from the destination server to the access point and thereafter to the STA, before the STA can respond to the congestion. In some deployments, this round-trip delay may be high, thereby reducing the responsiveness of the STA to the congestion, which can lead to packets being dropped at the access point. The devices and methods discussed herein may, therefore, implement a mechanism that facilitates provision of a faster response to the congestion experienced at the access point. The devices and methods discussed herein allow signaling of L4S congestion in a reverse direction.

The devices and methods discussed herein perform reverse signaling of congestion in LAS data flows. A device, for example, an access point, may receive a first LAS data flow including a plurality of first data packets, from a first direction, and detect a congestion associated with the first LAS data flow. The access point may identify a second LAS data flow, including a plurality of second data packets, from a second direction reverse to the first direction, associated with the first L4S data flow. The access point may mark one or more of the second data packets with a congestion indicator indicative of the congestion associated with the first LAS data flow. The congestion indicator may provide a fast congestion notification associated with the L4S data flow in one direction by utilizing the LAS data flow in the reverse direction, to facilitate a fast response to the congestion and a reduction of congestion-related packet drops at the access point.

By way of a non-limiting example, an access point may receive a downstream LAS data flow including a plurality of downstream data packets from a network device, for example, a destination server, and detect a congestion associated with the downstream LAS data flow. In yet more embodiments, the downstream LAS data flow may be indicative of a first source address associated with the destination server and a first destination address associated with a wireless device, for example, a STA. To detect the congestion associated with the downstream L4S data flow, in still yet more embodiments, the access point may store one or more of the downstream data packets in a queue, determine a count of the downstream data packets in the queue, and compare the count of the downstream data packet(s) with a threshold count. In many further embodiments, the access point may detect the congestion based on the count of the downstream data packets exceeding the threshold count.

The access point may then identify an upstream LAS data flow, including a plurality of upstream data packets, from the STA. The upstream L4S data flow may be associated with the downstream L4S data flow. For example, the access point may receive one or more upstream LAS data flows from the STA, and determine that an upstream L4S data flow of the one or more upstream LAS data flows is associated with a second source address associated with the STA and a second destination address associated with the destination server. The upstream LAS data flow associated with the second source address associated with the STA and the second destination address associated with the destination server may correspond to the identified upstream LAS data flow. The access point may mark one or more of upstream data packets of the identified upstream LAS data flow with a congestion indicator indicative of the congestion associated with the downstream L4S data flow. The congestion indicator may indicate that congestion is experienced in a reverse direction (e.g., a downstream direction). In many additional embodiments, the congestion indicator may be marked in one of a Layer 3 header or a higher layer header than the layer 3 header of the upstream data packets to indicate the congestion in the downstream direction. In many further embodiments, the congestion indicator may correspond to one of: one or more bits in an IP Option field of an IP version 4 (IPv4) header, one or more bits in a Flags field in the IPv4 header, or one or more bits in an Extension header in an IP version 6 (IPv6) header. In many more embodiments, the congestion indicator may correspond to a specific value in a Differentiated Services Code Point (DSCP) field in an IP header, for example, a DSCP value “63” with all 6 DSCP bits set to 1. The congestion indicator may provide a fast congestion notification associated with the downstream LAS data flow by utilizing the upstream LAS data flow, to facilitate a fast response to the congestion and a reduction of congestion-related packet drops at the access point. The access point may transmit the upstream data packet(s) marked with the congestion indicator to the destination server generating the downstream L4S data flow associated with the detected congestion or to one or more network devices in an upstream network path leading to the destination server.

In still yet further embodiments, for a downstream LAS data flow received from the network device, the access point may detect the congestion based on the status of the queue. The access point can thereafter determine an IP tuple associated with the downstream LAS data flow. The IP tuple can be indicative of source and destination IP addresses, source and destination port numbers, or protocols, etc., associated with the downstream LAS data flow. The access point may determine an upstream LAS data flow associated with a reverse IP tuple, that is, the upstream L4S data flow where the source and destination IP addresses and/or source and destination port numbers may be reversed. The access point can insert a congestion indicator in one or more upstream data packets of the upstream LAS data flow to signal congestion in a reverse direction, for example, the downstream direction.

By way of another non-limiting example, the access point may receive, from the STA, one or more upstream LAS data flows. The access point may further detect a congestion associated with an upstream LAS data flow of the one or more upstream L4S data flows. In several embodiments, the upstream LAS data flow may include a plurality of upstream data packets and may be indicative of a first source address associated with the STA and a first destination address associated with the destination server. To detect the congestion associated with the upstream L4S data flow, in several more embodiments, the access point may store one or more of the upstream data packets in a queue, determine a count of the upstream data packets in the queue, and compare the count of the upstream data packets with a threshold count. In numerous embodiments, the access point may detect the congestion based on the count of the upstream data packets exceeding the threshold count. In numerous additional embodiments, the access point may detect the congestion associated with the upstream LAS data flow at an egress path from the access point to the destination server.

The access point may then identify a downstream L4S data flow, including a plurality of downstream data packets, from the destination server. The downstream LAS data flow may be associated with the upstream LAS data flow. To identify the downstream LAS data flow, the access point may receive the downstream LAS data flow from the destination server, and determine that the downstream LAS data flow is associated with a second source address associated with the destination server and a second destination address associated with the STA. The access point may mark one or more of the downstream data packets with a congestion indicator indicative of the congestion associated with the upstream L4S data flow. In some more embodiments, if the access point detects a congestion associated with the upstream L4S data flow, the access point may generate a congestion signaling request configured to indicate the detected congestion and transmit a congestion indicator, for example, a Layer 2 signaling, to the STA based on the generated congestion signaling request. In a number of embodiments, the congestion indicator may be indicative of the congestion associated with the upstream L4S data flow. The congestion indicator, in the above embodiments, may provide a fast congestion notification associated with the upstream LAS data flow by utilizing the downstream LAS data flow, to facilitate a fast response to the congestion and a reduction of congestion-related packet drops at the access point. The access point may transmit the downstream data packet(s) marked with the congestion indicator to the STA.

In a variety of embodiments, the devices and methods discussed herein can signal congestion at the access point before or at the time of transmitting the data packets that experience the congestion. The access point can also notify the congestion in both upstream and downstream data flows. In various embodiments, the access point may notify the congestion to the STA by way of Layer 2 signaling and can notify the congestion to the destination server by marking one of a Layer 3 header or a higher layer header than the Layer 3 header in upstream data packet(s) with a congestion indicator. The devices and methods discussion herein may reduce a time required for notifying the congestion to the STA and the destination server, thereby improving efficiency of the wireless communication network.

Aspects of the present disclosure may be embodied as an apparatus, a system, a method, or a computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. Nevertheless, the executables of an identified function need not be physically located together but may comprise disparate instructions stored in different locations which, when joined logically together, comprise the function and achieve the stated purpose for the function.

A function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages, or the like) or other discrete electrical devices, in electrical communication with one or more other components through electrical lines of a Printed Circuit Board (PCB) or the like. Each of the functions and/or modules described herein, in more embodiments, may alternatively be embodied by or implemented as a component.

A circuit, as used herein, comprises a set of one or more electrical and/or electronic components providing one or more pathways for electric current. In additional embodiments, a circuit may include a return pathway for electric current, so that the circuit is a closed loop. In further embodiments, however, a set of components that does not include a return pathway for electric current may be referred to as a circuit (e.g., an open loop). For example, an integrated circuit may be referred to as a circuit regardless of whether the integrated circuit is coupled to ground (as a return pathway for electric current) or not. In still more embodiments, a circuit may include a portion of an integrated circuit, an integrated circuit, a set of integrated circuits, a set of non-integrated electrical and/or electrical components with or without integrated circuit devices, or the like. In still further embodiments, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a PCB or the like. Each of the functions and/or modules described herein, in still additional embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

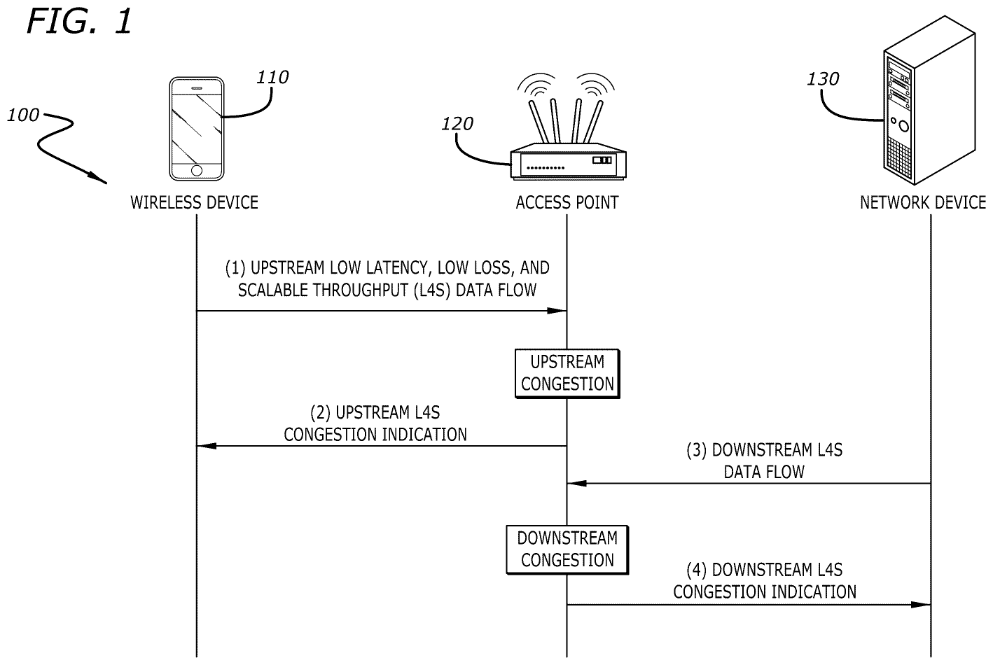

Referring to FIG. 1, a schematic diagram of a wireless communication network 100 in accordance with various embodiments of the disclosure is shown. In many embodiments, the wireless communication network 100 may be a Wireless Local Area Network (WLAN), for example, a Wi-Fi® network. By way of a non-limiting example, the embodiments shown in FIG. 1 illustrate the wireless communication network 100 including a wireless device 110, an access point 120, and a network device 130. The wireless device 110 may be a station (herein referred to as an “STA”). The STA may refer to any device including end-user devices or client devices such as laptops, tablets, smartphones, gaming consoles, dual-mode cellular phones, wireless Voice-over-Internet Protocol (VOIP) phones, mobile stations, personal digital assistants (e.g., converged devices that support WLAN data and/or voice, and cellular), wearable devices, other devices such as printers, Internet-of-Things (IoT) devices, or network infrastructure devices such as wireless mesh nodes, that can connect to the wireless communication network 100. The STA can be in a client mode, acting as a client device. When acting as a client device, the STA may connect to the access point 120 to gain access to the wireless communication network 100.

The access point 120 may refer to a networking device that couples the wireless device 110 to a wired network, for example, a Local Area Network (LAN). The access point 120 may allow wireless devices to connect to the wired network by utilizing, for example, Wi-Fi® or other wireless technologies. The access point 120 may act as a bridge between the wired network and the wireless devices, enabling the wireless devices to access the wired network, share resources, and communicate with other devices. The access point 120 may, for example, be one or more of a non-multi-link device (MLD) access point, an access point affiliated with an access point MLD, and/or an access point MLD. The network device 130 may refer to a server, for example, a destination server such as a cloud server, configured to receive or handle data being transmitted from a source, for example, the wireless device 110.

In a number of embodiments, the devices and methods discussed herein may perform reverse signaling of congestion in Low Latency, Low Loss, and Scalable throughput (L4S) data flows. The devices and methods discussed herein may signal L4S congestion experienced at the access point 120, in the reverse direction for upstream and downstream L4S data flows, which may allow faster LAS congestion signaling leading to a faster response to the congestion and hence a reduction of congestion-related packet drops at the access point 120. The upstream and downstream LAS data flows may encounter, for example, network bottlenecks, router or switch queue overflows, buffer bloats, or bandwidth overloads, leading to congestion which may cause the data packets to either be delayed, queued for too long, or dropped altogether, resulting in reduced throughput. The congestion may occur when more data is transmitted through the wireless communication network 100 than the wireless communication network 100 can handle efficiently. For example, if the amount of data transmitted by the wireless device 110 or the network device 130 exceeds the available bandwidth, that is, the maximum rate at which the data can be transferred over the wireless communication network 100, or if there is heavy traffic in a network path, congestion may occur and queues may overflow.

Consider an example where the access point 120 receives an upstream LAS data flow including upstream L4S data packets or traffic from the wireless device 110. The upstream LAS data flow may refer to a transmission of data flowing upstream from the wireless device 110 towards the network device 130 by utilizing LAS technology, for example, while uploading a file, transmitting a request, streaming data to a server, or the like. In a variety of embodiments as illustrated in FIG. 1, if the access point 120 experiences an upstream congestion in the upstream LAS data flow, herein referred to as “upstream L4S congestion”, from the wireless device 110 to the network device 130, the access point 120 may signal the upstream LAS congestion in a reverse direction by inserting an upstream L4S congestion indication in one or more downstream data packets of a downstream LAS data flow. The downstream LAS data flow may refer to a transmission of data flowing downstream from the network device 130 towards the wireless device 110 by utilizing LAS technology, for example, when the wireless device 110 receives data such as while downloading a file, streaming a video, or receiving data updates from a remote server, or the like. In various embodiments as illustrated in FIG. 1, if the access point 120 experiences a downstream congestion in the downstream LAS data flow, herein referred to as “downstream LAS congestion”, from the network device 130 to the wireless device 110, the access point 120 may signal the downstream LAS congestion in a reverse direction by inserting a downstream LAS congestion indication in one or more upstream data packets of an upstream L4S data flow.

In more embodiments, if the access point 120 experiences a downstream LAS congestion, the access point 120 may, at the transport layer implementing, for example, the Transmission Control Protocol (TCP), mark Explicit Congestion Encountered (ECE) bits on data packets flowing in a reverse direction, that is, an upstream direction, for the same Internet Protocol (IP) tuple, to indicate to the network device 130 that the congestion is experienced in the downstream direction. An IP tuple may refer to a set of different values that comprise a TCP/IP connection. The IP tuple may include, for example, a source IP address/port number, a destination IP address/port number, and the protocol in use. The access point 120 may examine LAS data flows, for example, with reversed source and destination IP addresses, ports, etc., to identify a reverse IP tuple associated with the downstream LAS data flow, and then mark the ECE bits on the data packets flowing in the reverse direction, that is, the upstream direction, to indicate to the network device 130 that the congestion is experienced in the downstream direction. Similarly, if the access point 120 experiences an upstream LAS congestion, in additional embodiments, the access point 120 may, at the transport layer implementing, for example, the TCP, may mark ECE bits on data packets flowing in a reverse direction, that is, a downstream direction, for the same IP tuple, to indicate to the wireless device 110 that the congestion is experienced in the upstream direction. In some more embodiments, if the access point 120 experiences an upstream LAS congestion, the access point 120 can also utilize Layer 2 signaling in data packets flowing in a reverse direction, that is, a downstream direction, for the same IP tuple, to indicate to the wireless device 110 that the congestion is experienced in the upstream direction.

For the sake of brevity and in a non-limiting example, the wireless communication network 100 is shown in FIG. 1 to include only one wireless device 110, one access point 120, and one network device 130. However, in an actual implementation, the wireless communication network 100 can include any number of wireless devices, access points, and network devices spread across different locations for facilitating reverse signaling of upstream congestion and downstream congestion.

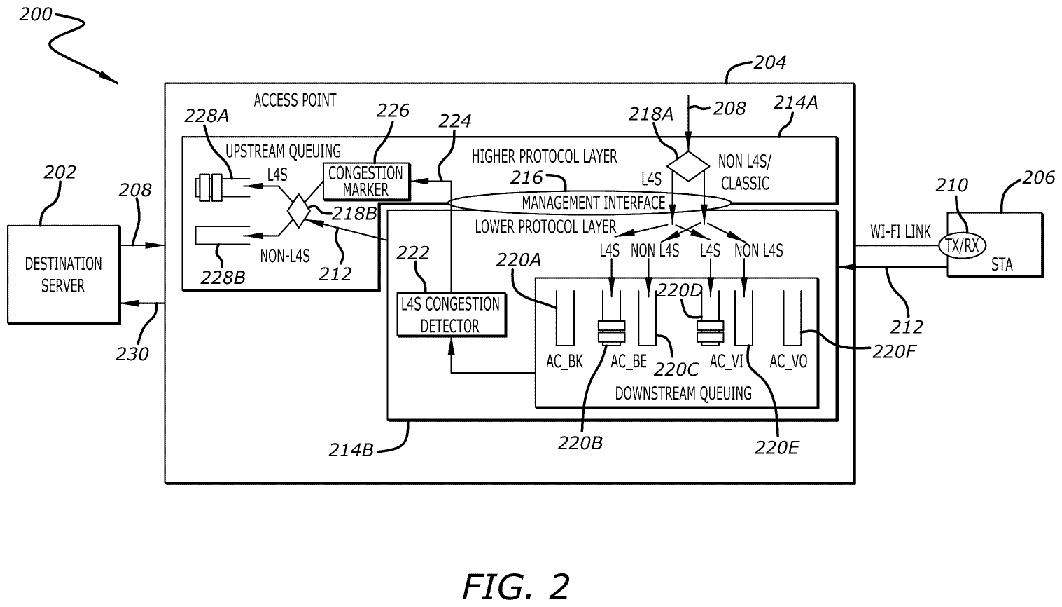

Although a specific embodiment for a wireless communication network 100 suitable for carrying out the various steps, processes, methods, and operations described herein is discussed with respect to FIG. 1, any of a variety of systems and/or processes may be utilized in accordance with embodiments of the disclosure. For example, in further embodiments, for other protocols implemented in the transport layer, for example, Stream Control Transmission Protocol (SCTP), Real-Time Protocol (RTP)/UDP, Quick UDP Internet Connections (QUIC), Datagram Congestion Control Protocol (DCCP), or the like, instead of marking the ECE bits on the data packets flowing in the reverse direction, the access point 120 may provide equivalent accurate ECN feedback on the data packets for the same IP tuple, to indicate to the network device 130 or the wireless device 110 that the congestion is experienced in the downstream direction or the upstream direction, respectively. This feedback can be provided using a field in an IP header or a field at a higher layer. The elements depicted in FIG. 1 may also be interchangeable with other elements of FIGS. 2-12 as required to realize a particularly desired embodiment.

Referring to FIG. 2, a block diagram of a system 200 illustrating a reverse signaling of downstream congestion in a wireless communication network in accordance with various embodiments of the disclosure is shown. Consider an example where a wireless device such as a client device or a station, herein referred to as an “STA 206”, connects to an Access Point (AP) 204 wirelessly using a Wi-Fi® protocol, which may allow the STA 206 to communicate with other devices in the wireless communication network. The access point 204 may be connected to a local network, which in turn, may be connected to the internet or a network device. In some embodiments, the network device can be a server. In some more embodiments, the network device can be an intermediate network node (for example, another access point, a switch, a router, etc.) connecting the access point 204 to the server. In a non-limiting example, the access point 204 is shown to be connected to a destination server 202 in FIG. 2. The destination server 202 may refer to a remote server that can host, for example, services, websites, files, or data. The destination server 202 may, for example, be a web server, an application server, a file server, or any other type of server that provides resources. The destination server 202 may transmit first network traffic, for example, LAS traffic, in a downstream direction towards the STA 206 via the access point 204. A transmitter (Tx)/receiver (Rx) 210 of the STA 206 may transmit second network traffic, for example, LAS traffic, in an upstream direction towards the destination server 202 via the access point 204.

In the embodiments illustrated in FIG. 2, the access point 204 may implement a higher protocol layer 214A and a lower protocol layer 214B of a network stack defined by an Open Systems Interconnection (OSI) model. In many embodiments, the lower protocol layer 214B may refer to a data link layer or layer 2 including a Media Access Control (MAC) sublayer. The MAC sublayer may execute core functions including, for example, channel access, retransmissions, packet fragmentation, and encryption. The MAC sublayer may control access to a shared communication medium in the wireless communication network, ensuring that various network devices (STAs and access points) can transmit data effectively and fairly over a common communication network such as a Wi-Fi® network. The MAC sublayer may define a hardware or data link address referred to as a MAC address. This MAC address is unique to each network device. The MAC sublayer may utilize MAC addresses to identify network devices, for example, the STA 206, the access point 204, and the destination server 202, in the wireless communication network. The MAC sublayer may also control how the STA 206 or the access point 204 accesses and transmits data. The MAC sublayer may be configured to encapsulate data into frames that are transmitted over a wireless communication medium. These frames contain the MAC addresses of both a transmitter device and a receiver device. For the first network traffic coming from the destination server 202 and flowing in a downstream direction, herein referred to as a “downstream data flow 208”, towards the STA 206, the destination server 202 may be a source device with the access point 204 as the transmitter device and the STA 206 as the receiver device. For the second network traffic coming from the STA 206 and flowing in an upstream direction, herein referred to as an “upstream data flow 212”, towards the destination server 202, the STA 206 may be the source device with the access point 204 as the transmitter device and the destination server 202 may be the receiver device.

In a number of embodiments, the higher protocol layer 214A may include a network layer herein referred to as “layer 3”. The layer 3 may utilize IP addresses to uniquely identify the source device and the destination device and determine an optimal path for data to travel between the source device and the destination device. In a variety of embodiments, the higher protocol layer 214A may include a transport layer herein referred to as “layer 4”. The layer 4 may manage network traffic between the source device and the destination device to ensure complete data transfers. The layer 4 may utilize transport layer protocols, for example, TCP, UDP, DCCP, SCTP, or the like to control the volume of data, the destination for transmitting the data, and a rate of transmitting the data. The access point 204 may receive data from the higher protocol layer 214A such as the layer 3 or the layer 4, and encapsulate the data into frames, each with a transmitter address and a receiver address, in the lower protocol layer 214B. When the access point 204 receives frames from the STA 206, the lower protocol layer 214B may decapsulate the frames to extract a payload and forward the data to the higher protocol layer 214A for processing.

The higher protocol layer 214A may be operably coupled to the lower protocol layer 214B via a management interface 216. The management interface 216 may refer to a structured communication entity that allows exchange of data between the higher protocol layer 214A and the lower protocol layer 214B. The management interface 216 may invoke layer management functions, for example, handing off data packets correctly between the higher protocol layer 214A and the lower protocol layer 214B. In various embodiments, the management interface 216 may be a MAC-SAP. In more embodiments, the management interface 216 may be an MAC layer management entity (MLME). The MLME may handle higher MAC functions including, for example, synchronization, power management, and connection management, which include association and authentication. The MLME may manage channel access rules and algorithms, ensuring that the network devices can appropriately gain access to the shared communication medium. The MLME may also manage beacon frames in the wireless communication network and control whether the network devices utilize Carrier Sense Multiple Access (CSMA)/Collision Avoidance (CA), CSMA/Collision Detection (CD), or other access mechanisms. The MLME may communicate with the lower protocol layer 214B, for example, the MAC sublayer, and handle higher-level management functions and decisions that influence the operation of the MAC sublayer. The MLME may also communicate with the higher protocol layer 214A to inform the higher protocol layer 214A about the state of the wireless communication network, any security procedures, or changes in a network topology. In additional embodiments, the higher protocol layer 214A and the lower protocol layer 214B may communicate with each other by exchanging service primitives through the management interface 216.

The higher protocol layer 214A may include one or more classifiers, for example, ECN classifiers 218A and 218B. In further embodiments, the ECN classifiers 218A and 218B may be configured to classify network traffic of different types based on Differentiated Services Code Points (DSCP) or other packet markings, thereby allowing the ECN classifiers 218A and 218B to apply ECN marking to specific types of network traffic that needs congestion management. The access point 204 may receive a downstream data flow 208 including a plurality of downstream data packets from the destination server 202, through the higher protocol layer 214A. In still more embodiments, the ECN classifier 218A in the higher protocol layer 214A may receive the downstream data packets and distinguish between LAS data packets and non-L4S/classic congestion control data packets by inspecting an ECN field and DSCP in headers of the data packets. These fields indicate whether the data packets should be stored in L4S queues 220B and 220D or non-L4S/classic queues 220C and 220E in the lower protocol layer 214B. In still further embodiments, the L4S queues 220B and 220D in the lower protocol layer 214B may be low latency queues configured to store L4S data packets. In still additional embodiments, the non-LAS queues 220C and 220E may be classic queues configured to store non-LAS data packets. In some more embodiments, the ECN classifier 218A may execute a queuing scheme that prioritizes transmission of the L4S data packets in the L4S queues 220B and 220D over the non-LAS data packets in the non-L4S queues 220C and 220E.

The lower protocol layer 214B may receive the downstream data packets from the higher protocol layer 214A via the management interface 216. The downstream data packets may undergo downstream queuing in the lower protocol layer 214B, where the downstream data packets are stored in multiple queues, for example, the queues 220A, 220B, 220C, 220D, 220E, and 220F as illustrated in FIG. 2. The queues 220A, 220B, 220C, 220D, 220E, and 220F are herein collectively referred to as “the queues 220A-220F”. In yet various embodiments, the queues 220A-220F may be defined by Access Categories (ACs), with each access category being associated with a respective priority level. The access categories may include, for example, a background (BK) access category, a Best Effort (BE) access category, a video (VI) access category, and a voice (VO) access category, denoted as AC_BK, AC_BE, AC_VI, and AC_VO, respectively. In yet more embodiments, the access categories may be in order of priority, from highest to lowest priority, for example: AC_VO, AC_VI, AC_BE, and AC_BK. By way of a non-limiting example, in still yet more embodiments, the ECN classifier 218A may queue some LAS data packets and non-LAS data packets from the downstream data flow 208 in the queues 220B and 220C, respectively, defined as AC_BE queues, and some LAS data packets and non-L4S data packets in the queues 220D and 220E, respectively, defined as AC_VI queues, as illustrated in FIG. 2. In further embodiments, there can be LAS and non-L4S queues defined for an AC_VO access category as well without deviating from the scope of the disclosure. The LAS data packets in the queues 220B and 220D may experience downstream congestion, for example, if the destination server 202 transmits the LAS data packets at a higher speed than the access point 204 can process and deliver to the STA 206.

Similarly, the access point 204 may receive one or more upstream data flows, for example, an upstream data flow 212 including a plurality of upstream data packets from the STA 206, into the lower protocol layer 214B. In many further embodiments, the ECN classifier 218B in the higher protocol layer 214A may receive the upstream data packets from the lower protocol layer 214B via the management interface 216 and distinguish between LAS data packets and non-LAS data packets by inspecting an ECN field and DSCP in headers of the data packets. The upstream data packets may undergo upstream queuing in the higher protocol layer 214A, where the upstream data packets are stored in two queues, for example, an LAS queue 228A and a non-L4S queue 228B as illustrated in FIG. 2. In further embodiments, different L4S and non-L4S queues for upstream data packets can be defined for different priority levels. For example, two LAS queues can be defined for L4S upstream data packets of best effort (BE) and Video (VI) priority level, and similarly two non-LAS queues can be defined for non-LAS upstream data packets of best effort (BE) and Video (VI) priority level. In many further embodiments, there can be LAS and non-LAS queues defined for an AC_VO access category as well without deviating from the scope of the disclosure. In many additional embodiments, the LAS queue 228A in the higher protocol layer 214A may be a low latency queue configured to store one or more L4S data packets. In still yet further embodiments, the non-LAS queue 228B may be a classic queue configured to store one or more non-LAS data packets. In still yet additional embodiments, the ECN classifier 218B may execute a queuing scheme that prioritizes transmission of the L4S data packets in the L4S queue 228A over the non-LAS data packets in the non-LAS queue 228B.

In several embodiments, the access point 204 may further include an LAS congestion detector 222 implemented, for example, in the lower protocol layer 214B and a congestion marker 226 implemented, for example, in the higher protocol layer 214A. In several more embodiments, the LAS congestion detector 222 may be operably coupled to the congestion marker 226. In numerous embodiments, the LAS congestion detector 222 may be configured to detect downstream LAS congestion in the lower protocol layer 214B. In numerous additional embodiments, the L4S congestion detector 222 may be configured to inspect each of the LAS queues in the lower protocol layer 214B, for example, the L4S queues 220B and 220D defined by AC_BE and AC_VI, respectively, and detect the downstream LAS congestion. In further additional embodiments, the LAS congestion detector 222 may detect the downstream LAS congestion based on queue depth. For example, the LAS congestion detector 222 may continuously inspect the queue depth and detect the downstream LAS congestion if the queue depth is greater than or equal to a threshold count of data packets in the queue 220B or 220D. In many embodiments, the L4S congestion detector 222 may configure the threshold count to maximize throughput. In a number of embodiments, the L4S congestion detector 222 may employ minimum and maximum queue depth thresholds to detect the downstream LAS congestion. In a variety of embodiments, based on the detected congestion and on receiving a signal 224 from the L4S congestion detector 222 in the lower protocol layer 214B, the congestion marker 226 in the higher protocol layer 214A may be configured to mark one or more data packets of a reverse flow, for example, an upstream data flow with a congestion indicator. For example, the congestion indicator may be a field in the IP header indicating that congestion is experienced in a reverse direction. In further examples, the congestion indicator may be a bit in a Flags field in an IPv4 header indicating that congestion is experienced in the reverse direction. In many further examples, the congestion indicator may be a part of an IP Option field in the IPv4 header. In additional examples, the congestion indicator may be a part of an Extension header in an IPv6 header indicating that congestion is experienced in the reverse direction. In yet additional examples, a specific DSCP value in the IP header may be used as the congestion indicator to indicate congestion in the reverse direction.

Therefore, to reverse signal the downstream LAS congestion, the congestion marker 226 may mark one or more of the upstream data packets of the upstream data flow 212 with the congestion indicator. In more embodiments, the congestion marker 226 may be operably coupled to the ECN classifier 218B in the higher protocol layer 214A. The ECN classifier 218B may receive the marked upstream data packets from the congestion marker 226 and can classify the upstream data packets into the queues 228A and 228B. The embodiments illustrated in FIG. 2 are described in the context of reverse signaling of downstream congestion in a wireless communication network. Consider an example where network traffic from the destination server 202 flows in the downstream direction towards the STA 206. The access point 204 may receive this downstream data flow 208 including multiple downstream data packets from the destination server 202. The access point 204 may receive the downstream data flow 208 at the higher protocol layer 214A. In additional embodiments, the downstream data flow 208 may be indicative of a source address, for example, a source IP address, associated with the destination server 202, and a destination address, for example, a destination IP address, associated with the STA 206. The ECN classifier 218A in the higher protocol layer 214A may receive the downstream data flow 208 and classify the downstream data packets of the downstream data flow 208 into downstream L4S data packets and downstream non-LAS data packets. In the lower protocol layer 214B, the downstream LAS data packets and the downstream non-LAS data packets are stored in the LAS queues 220B and 220D and the non-L4S queues 220C and 220E, respectively.

The L4S congestion detector 222 may detect a downstream congestion in the L4S queues 220B and 220D as disclosed above. In further embodiments, the L4S congestion detector 222 may determine a count of the downstream LAS data packets in the LAS queues 220B and 220D and compare the count of the downstream LAS data packets with a threshold count. The LAS congestion detector 222 may detect the congestion based on the count of the downstream LAS data packets exceeding the threshold count. On detecting the downstream congestion, the L4S congestion detector 222 may transmit a signal 224 to the congestion marker 226 in the higher protocol layer 214A. In the above example, the access point 204 may also receive network traffic flowing in the upstream direction, for example, towards the destination server 202, coming from the STA 206. The access point 204 may receive this upstream data flow 212 including multiple upstream data packets, into the lower protocol layer 214B, from the STA 206. The upstream data flow 212 may be associated with the downstream data flow 208. In still more embodiments, the congestion marker 226 may identify the upstream data flow 212 from the one or more upstream data flows by determining that the upstream data flow 212 is associated with a source address of the STA 206 and a destination address of the destination server 202. The source address of the STA 206 and the destination address of the destination server 202 may, for example, be IP addresses. The congestion marker 226 may examine the upstream data flow 212 for data packets with reversed source and destination IP addresses, ports, etc., to identify a reverse IP tuple associated with the downstream LAS data packets in the downstream data flow 208. In other words, the upstream data flow 212 may be associated with the downstream data flow 208 based on a reversed-IP tuple relationship.

The congestion marker 226 may then mark one or more of the upstream LAS data packets having the identified reverse IP tuple, that are flowing in the upstream direction, with a congestion indicator, to indicate to the destination server 202 that the congestion is experienced in the downstream direction. In still further embodiments, the congestion indicator may be marked in one of a Layer 3 header or a higher layer header than the Layer 3 header of the one or more upstream L4S data packets to indicate the congestion in a downstream direction. For example, the congestion indicator may correspond to one of: one or more bits in an IP Option field of an IPv4 header, one or more bits in a Flags field in the IPv4 header, one or more bits in an Extension header in an IPv6 header, or a specific value in a DSCP field in the IP header. In many further embodiments, the one or more of the upstream LAS data packets may have been marked as LAS enabled data packets by setting ECN bits to 01 in the IP header. Such marking of the one or more of the upstream LAS data packets enables prioritization in an LAS queue. The congestion marker 226 may transmit the marked upstream LAS data packets to the ECN classifier 218B. In response to receiving the marked upstream LAS data packets, the ECN classifier 218B stores the marked upstream LAS data packets into the LAS queue 228A. The access point 204 may transmit the upstream LAS data packets 230 marked with the congestion indicator to the destination server 202. In a scenario where the destination server 202 is connected to the access point 204 via one or more intermediate network devices, the access point 204 may transmit the upstream L4S data packets 230 marked with the congestion indicator to the one or more intermediate network devices on upstream network path leading to the destination server 202. The reverse direction congestion marking at Layer 3 or a higher protocol layer than the Layer 3 may signal the downstream congestion to the destination server 202 without causing significant delays. The destination server 202 may then adjust its transmission rate, for example, reduce the transmission rate, in response to the indicated downstream L4S congestion, to reduce the downstream LAS congestion.

Although a specific embodiment for a system 200 illustrating a reverse signaling of downstream congestion in a wireless communication network suitable for carrying out the various steps, processes, methods, and operations described herein is discussed with respect to FIG. 2, any of a variety of systems and/or processes may be utilized in accordance with embodiments of the disclosure. For example, in some more embodiments, the devices and methods discussed herein may employ other different methods and congestion detection algorithms for detecting downstream congestion, for example, by utilizing Round Trip Time (RTT) measurements as secondary signals of congestion, monitoring packet losses, Active Queue Management (AQM) algorithms that provide AQM feedback, or the like. The elements depicted in FIG. 2 may also be interchangeable with other elements of FIG. 1 and FIGS. 3-12 as required to realize a particularly desired embodiment.

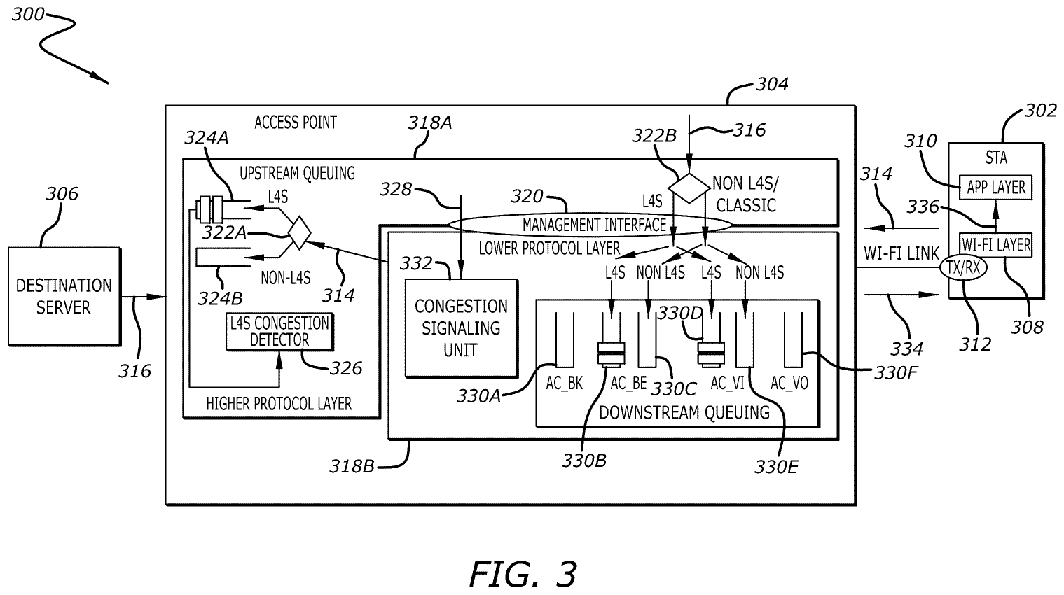

Referring to FIG. 3, a block diagram of a system 300 illustrating a reverse signaling of upstream congestion in a wireless communication network in accordance with various embodiments of the disclosure is shown. Consider an example where a wireless device such as a client device or a station, herein referred to as an “STA 302”, connects to an Access Point (AP) 304 wirelessly using a Wi-Fi® protocol, which may allow the STA 302 to communicate with other devices in the wireless communication network. The access point 304 may be connected to a local network, which in turn, may be connected to the internet or a network device. In some embodiments, the network device can be a server. In some more embodiments, the network device can be an intermediate network node (for example, another access point, a switch, a router, etc.) connecting the access point 304 to the server. In a non-limiting example, the access point 304 is shown to be connected to a destination server 306 in FIG. 3. A Tx/Rx 312 of the STA 302 may transmit first network traffic, for example, LAS traffic, in an upstream direction towards the destination server 306 via the access point 304. The destination server 306 may transmit second network traffic, for example, LAS traffic, in a downstream direction towards the STA 302 via the access point 304.

In the embodiments illustrated in FIG. 3, the access point 304 may implement a higher protocol layer 318A and a lower protocol layer 318B of a network stack defined by an OSI model. In many embodiments, the lower protocol layer 318B may refer to a data link layer or layer 2 including a MAC sublayer. The MAC sublayer may utilize MAC addresses to identify network devices, for example, the STA 302 and the destination server 306, in the wireless communication network. The MAC sublayer may also control how the STA 302 or the destination server 306 accesses and transmits data. The MAC sublayer may be configured to encapsulate data into frames that are transmitted over a wireless communication medium. These frames contain the MAC addresses of both a transmitter device and a receiver device. For the first network traffic coming from the STA 302 and flowing in an upstream direction, herein referred to as an “upstream data flow 314”, towards the destination server 306, the STA 302 may be a source device with the access point 304 as the transmitter device and the destination server 306 may be the receiver device. For the second network traffic coming from the destination server 306 and flowing in a downstream direction, herein referred to as a “downstream data flow 316”, towards the STA 302, the destination server 306 may be the source device with the access point 304 as the transmitter device and the STA 302 may be the receiver device.

In a number of embodiments, the higher protocol layer 318A may include a network layer herein referred to as “layer 3”. The layer 3 may utilize IP addresses to uniquely identify the source device and the destination device and determine an optimal path for data to travel between the source device and the destination device. In a variety of embodiments, the higher protocol layer 318A may include a transport layer herein referred to as “layer 4”. The layer 4 may manage network traffic between the source device and the destination device to ensure complete data transfers. The higher protocol layer 318A may be operably coupled to the lower protocol layer 318B via a management interface 320. The management interface 320 may refer to a structured communication entity that allows exchange of data between the higher protocol layer 318A and the lower protocol layer 318B. The management interface 320 may invoke layer management functions, for example, handing off data packets correctly between the higher protocol layer 318A and the lower protocol layer 318B. In various embodiments, the management interface 320 may be a MAC-SAP. In more embodiments, the management interface 320 may be an MLME. The MLME may communicate with the lower protocol layer 318B, for example, the MAC sublayer, and handle higher-level management functions and decisions that influence the operation of the MAC sublayer. The MLME may also communicate with the higher protocol layer 318A to inform the higher protocol layer 318A about the state of the wireless communication network, any security procedures, or changes in a network topology. In additional embodiments, the higher protocol layer 318A and the lower protocol layer 318B may communicate with each other by exchanging primitives through the management interface 320.

The higher protocol layer 318A may include one or more classifiers, for example, ECN classifiers 322A and 322B. In further embodiments, the ECN classifiers 322A and 322B may be configured to classify network traffic of different types based on DSCP or other packet markings, thereby allowing the ECN classifiers 322A and 322B to apply ECN marking to specific types of network traffic that needs congestion management. The access point 304 may receive an upstream data flow 314 including a plurality of upstream data packets from the STA 302, into the lower protocol layer 318B. In still more embodiments, the ECN classifier 322A in the higher protocol layer 318A may receive the upstream data packets from the lower protocol layer 318B via the management interface 320 and distinguish between LAS data packets and non-LAS data packets by inspecting an ECN field and DSCP in headers of the data packets. The upstream data packets may undergo upstream queuing in the higher protocol layer 318A, where the upstream LAS data packets and the upstream non-LAS data packets are stored in two queues, for example, an LAS queue 324A and a non-LAS queue 324B, respectively, as illustrated in FIG. 3. In further embodiments, multiple L4S and non-LAS queues may be deployed for different priority levels such as separate queues for best effort, video, voice priority levels. In still further embodiments, the L4S queue 324A in the higher protocol layer 318A may be low latency queues configured to store one or more L4S data packets. In still additional embodiments, the non-LAS queue 324B may be a classic queue configured to store one or more non-L4S data packets. In some more embodiments, the ECN classifiers 322A may execute a queuing logic that prioritizes transmission of the L4S data packets in the LAS queue 324A over the non-LAS data packets in the non-LAS queue 324B. The LAS data packets in the L4S queue 324A may experience upstream congestion, for example, if the STA 302 transmits the L4S data packets at a higher speed than the access point 304 can process and deliver to the destination server 306.

In yet various embodiments, the access point 304 may include an L4S congestion detector 326 implemented in the higher protocol layer 318A. In yet more embodiments, the L4S congestion detector 326 may be configured to detect upstream LAS congestion in the higher protocol layer 318A. In still yet more embodiments, the LAS congestion detector 326 may be configured to inspect the LAS queues 324A in the higher protocol layer 318A and detect the upstream LAS congestion. In many further embodiments, the L4S congestion detector 326 may detect the upstream L4S congestion based on queue depth. For example, the L4S congestion detector 326 may continuously inspect the queue depth and detect the upstream L4S congestion if the queue depth is greater than or equal to a threshold count of data packets in the L4S queue 324A. In many additional embodiments, the L4S congestion detector 326 may configure the threshold count to maximize throughput. In still yet further embodiments, the L4S congestion detector 326 may employ minimum and maximum queue depth thresholds to detect the upstream LAS congestion.

The access point 304 may receive a downstream data flow 316 including a plurality of downstream data packets from the destination server 306, through the higher protocol layer 318A. In still yet additional embodiments, the ECN classifier 322B in the higher protocol layer 318A may receive the downstream data packets and distinguish between L4S data packets and non-L4S/classic congestion control data packets, for example, by inspecting an ECN field and DSCP in headers of the data packets. These fields indicate whether the downstream data packets should be stored in LAS queues 330B and 330D or non-LAS/classic queues 330C and 330E in the lower protocol layer 318B. In several embodiments, the L4S queues 330B and 330D in the lower protocol layer 318B may be low latency queues configured to store LAS data packets. In several more embodiments, the non-L4S queues 330C and 330E may be classic queues configured to store non-LAS data packets. In numerous embodiments, the ECN classifier 322B may execute a queuing logic that prioritizes transmission of the LAS data packets in the L4S queues 330B and 330D over the non-LAS data packets in the non-LAS queues 330C and 330E.

The lower protocol layer 318B may receive the downstream data packets from the higher protocol layer 318A via the management interface 320. The downstream data packets may undergo downstream queuing in the lower protocol layer 318B, where the downstream data packets are stored in multiple queues, for example, the queues 330A, 330B, 330C, 330D, 330E, and 330F as illustrated in FIG. 3. The queues 330A, 330B, 330C, 330D, 330E, and 330F are herein collectively referred to as “the queues 330A-330F”. In numerous additional embodiments, the queues 330A-330F may be defined by ACs, with each access category being associated with a respective priority level. The access categories may include, for example, a BK access category, a BE access category, a VI access category, and a VO access category, denoted as AC_BK, AC_BE, AC_VI, and AC_VO, respectively. By way of a non-limiting example, in further additional embodiments, the ECN classifier 322B may queue some LAS data packets and non-L4S data packets from the downstream data flow 316 in the queues 330B and 330C, respectively, defined as AC_BE queues, and some LAS data packets and non-LAS data packets in the queues 330D and 330E, respectively, defined as AC_VI queues, as illustrated in FIG. 3.

The embodiments illustrated in FIG. 3 are described in the context of reverse signaling of upstream congestion in a wireless communication network. Consider an example where network traffic (e.g., one or more upstream data flows) from the STA 302 flows in the upstream direction towards the destination server 306. The access point 304 may receive this upstream data flow 314 including multiple upstream data packets from the STA 302. The access point 304 may receive the upstream data flow 314 at the lower protocol layer 318B. In many embodiments, the upstream data flow 314 may be indicative of a source address, for example, a source IP address, associated with the STA 302, and a destination address, for example, a destination IP address, associated with the destination server 306. The ECN classifier 322A in the higher protocol layer 318A may receive the upstream data flow 314 from the lower protocol layer 318B and classify the upstream data packets of the upstream data flow 314 into upstream L4S data packets and upstream non-LAS data packets. In the higher protocol layer 318A, the upstream LAS data packets and the upstream non-LAS data packets are stored in the LAS queue 324A and the non-L4S queue 324B, respectively. An upstream congestion may be experienced in the L4S queue 324A at egress to the destination server 306.

The LAS congestion detector 326 may detect the upstream congestion in the LAS queue 324A. The LAS congestion detector 326 may detect the upstream congestion associated with the upstream data flow 314 at an egress point of a network path leading to the destination server 306. In a number of embodiments, the L4S congestion detector 326 may determine a count of the upstream LAS data packets in the L4S queue 324A and compare the count of the upstream LAS data packets with a threshold count. The L4S congestion detector 326 may detect the congestion based on the count of the upstream LAS data packets exceeding the threshold count. On detecting the upstream congestion, the L4S congestion detector 326 may generate a congestion signaling request 328 configured to indicate the detected congestion in upstream. In a variety of embodiments, the L4S congestion detector 326 may generate a southbound primitive at the management interface 320, for example, the MAC-SAP or the MLME, to indicate an upstream LAS congestion is experienced in the LAS queue 324A (at the egress to the destination server 306) at the access point 304. The southbound primitive labeled, for example, as a “LAS-CONG-SIGNAL.request” primitive, may be configured as the congestion signaling request 328. This southbound primitive may request the lower protocol layer 318B, for example, the MAC sublayer, to transmit L2 signaling for L4S congestion to the STA 302. In response, the MAC sublayer may transmit an LAS congestion experienced signal over L2 signaling to the STA 302. In various embodiments, the LAS congestion experienced signal may indicate a Traffic Identifier (TID) or a Stream Classification Service Identifier (SCSID) of the upstream data flow 314 that experienced the LAS congestion and the number of the upstream L4S data packets that experienced the LAS congestion. The STA 302 may utilize this information to scale down the transmission rate of an application(s) associated with that TID or SCSID. In more embodiments, the STA 302 can determine by how much to slow down its packet throughput for the upstream data flow 314.

In additional embodiments, the congestion signaling request may include at least one of: a priority of one or more upstream LAS data packets associated with the upstream congestion in the upstream data flow 314; an identifier of the upstream L4S data packets; an indication of a direction of the detected congestion, for example, the upstream direction; a count of the upstream LAS data packets; a percentage of upstream packets of the upstream data flow 314 that experienced congestion, or a probability of the congestion being experienced by upstream LAS data packets of the upstream data flow 314. For example, the congestion signaling request may indicate LAS traffic of which priority (e.g., BE or VI) experienced congestion in the LAS queue 324A at the access point 304; LAS traffic of which SCSID has experienced LAS congestion in the LAS queue 324 at the access point 304 (if known); the direction where the detected congestion is experienced; the number of upstream L4S data packets that experienced congestion; the percentage of LAS data packets that experienced congestion; or the probability of the congestion being experienced by upstream LAS data packets. By way of a non-limiting example, the LAS congestion detector 326 may transmit the congestion signaling request 328 in the following format:

```
L4S-CONG-SIGNAL.request(
  source address,
  destination address,
```

| | |
|---|---|
| direction, | ///set to upstream, where L4S congestion is experienced. |
| priority, | ///User Priority (UP)/TID of the L4S traffic which experienced |
| | L4S congestion |
| L4S CE SCSID, | ///SCSID of the SCS flow which experienced L4S congestion |
| Number of packets, | ///number of data packets for which L4S congestion experienced |
| Probability, | /// probability of L4S congestion being experienced |

```
  Percentage of packets /// percentage of data packets for which L4S congestion
  experienced
  )
```

In one or more embodiments, the access point 304 may further include a congestion signaling unit 332 implemented in the lower protocol layer 318B. The congestion signaling unit 332 may receive the congestion signaling request 328 from the LAS congestion detector 326 to initiate transmission of L2 signaling for the upstream L4S congestion to the STA 302. After receiving the congestion signaling request 328, in further embodiments, the congestion signaling unit 332 may transmit a congestion indicator to the STA 302 based on the generated congestion signaling request. The congestion indicator may be indicative of the congestion associated with the upstream data flow 314. In still more embodiments, the congestion signaling unit 332 may transmit the congestion indicator to the STA 302 as follows: the congestion signaling unit 332 may generate a Media Access Control (MAC) Protocol Data Unit (MPDU) including a congestion indication control field, for example, in a MAC header, and then transmit the MPDU to the STA 302. In still further embodiments, the congestion indication control field may include a value, for example, “1”, indicative of the congestion associated with the upstream data flow 314. In still additional embodiments, the congestion indication control field may be a separate L4S Congestion Indication (LCI) control subfield defined in the MPDU, which can be utilized to signal the congestion associated with the upstream data flow 314 and configured to indicate the upstream LAS congestion to the STA 302. In some more embodiments, a MAC header of the MPDU can include a High Throughput (HT) control field to transmit control information, which may be utilized to signal the congestion associated with the upstream data flow 314. In yet various embodiments, the MAC header of the MPDU may include a High Efficiency Aggregated Control (HE A-Control) field that can be utilized to signal the congestion associated with the upstream data flow 314.

In yet more embodiments, the access point 304 may transmit the congestion indicator to the STA 302 in at least one of a downstream data packet having the destination address of the STA 302, a Quality of Service (QOS) null frame, or a management frame. In still yet more embodiments, to transmit the congestion indicator to the STA 302 in at least one downstream data packet having the destination address of the STA 302, the congestion signaling unit 332 may examine the L4S queues 330B and 330D for data packets with reversed source and destination IP addresses, ports, etc., to identify a reverse IP tuple associated with the upstream L4S data packets in the upstream data flow 314. The congestion signaling unit 332 may then mark one or more of the downstream L4S data packets having the identified reverse IP tuple, that are flowing in the downstream direction, with the congestion indicator, to indicate to the STA 302 that the congestion is experienced in the upstream direction. In many further embodiments, the congestion indicator may be indicative of the congestion associated with the upstream data flow 314.

In still yet further embodiments, the STA 302 may implement a Wi-Fi layer 308 and an application layer 310. The Wi-Fi layer 308 of the STA 302 may include a MAC sublayer configured to perform functions similar to the MAC sublayer of the access point 304 disclosed above. The Wi-Fi layer 308 may handle communication between the STA 302 and the access point 304. The application layer 310 may perform higher-level functions and web application services including, for example, web browsing, transferring files, messaging, etc. The STA 302 may receive the downstream L4S data packet(s) marked with the congestion indicator for upstream data packets, at the Wi-Fi layer 308, and transmit a feedback signal 336 to the application layer 310 to signal to the application layer 310 to scale down a data rate or a rate of transmitting data to the destination server 306. The STA 302 may then adjust its transmission rate, for example, reduce the transmission rate, in response to the indicated upstream LAS congestion, to reduce the upstream L4S congestion. The devices and methods discussed herein allow the STA 302 to quickly respond to the upstream LAS congestion by allowing transmission of a faster upstream congestion notification to the STA 302 over the lower protocol layer 318B from the access point 304 to the STA 302.

Consider an example where the congestion signaling unit 332 receives the congestion signaling request 328 at the lower protocol layer 318B, for example, the MAC sublayer, of the access point 304. When an upstream LAS congestion is experienced in the LAS queue 324A, the congestion signaling unit 332 at the MAC sublayer may transmit a layer 2 signal 334 to the STA 302 to signal that there is an upstream LAS congestion. In still yet additional embodiments, the congestion signaling unit 332 may execute LAS congestion signaling by utilizing Aggregated-control (A-control) signaling in-band in data frames of a QoS null frame. A-control signaling may refer to congestion signaling executed, for example, through an A-control subfield of a High Efficiency (HE) variant High Throughput (HT) control field defined in a header of a data packet, a QoS null frame, or a management frame. In several embodiments, by utilizing A-control signaling in-band, control information may be transmitted within the same channel that is utilized for the downstream data flow 316. The control information may be embedded alongside at least one downstream data packet, the QoS null frame, or the management frame in the downstream direction.

In these embodiments, the congestion signaling unit 332 may define A-control signaling to indicate LAS congestion in-band in the data frames. The STA 302 may receive the layer 2 signal 334 at the Wi-Fi layer 308 via the Tx/Rx 312 and transmit a feedback signal 336 to the application layer 310 to signal to the application layer 310 to scale down a data rate or a rate of transmitting data to the destination server 306. The Wi-Fi layer 308 may generate the feedback signal 336 based on information included in the layer 2 signal 334. In several more embodiments, the layer 2 signal 334 may include a TID or an SCSID of the data flow 314 that experienced upstream LAS congestion and the number of upstream LAS data packets that experienced congestion. The STA 302 may utilize the information contained in the feedback signal 336 to scale down the transmission rate of an application(s) for that TID or SCSID.

In numerous embodiments, the congestion signaling unit 332 may generate a management frame to signal the upstream LAS congestion in the LAS queue 324A. For example, the congestion signaling unit 332 may generate a management frame labeled as “L4S Congestion Indication Notify” and transmit the management frame from the access point 304 to the STA 302. In numerous additional embodiments, the management frame is configured to carry the same set of information as captured in the LCI control subfield for A-control signaling. For example, the “L4S Congestion Indication Notify” management frame may include an LAS congestion direction which is the direction in which L4S congestion is experienced; LAS TID which is the UP/TID of the traffic which experienced the LAS congestion; the number of data packets which experienced LAS congestion; L4S SCSID of the SCS flow which experienced the LAS congestion; the percentage of upstream data packets that experienced congestion; or the probability of congestion experienced in the upstream, and any additional parameters related to L4S congestion signaling.

In further embodiments, upon receiving the congestion signaling request 328 at the lower protocol layer 318B, the congestion signaling unit 332 may utilize one or more other means that reduces the transmission rate of upstream data packets from the STA 302 to ease congestion in upstream queues at the access point 304 and to reduce packets drops due to congestion in the upstream queues. These other means can include, for example, transmitting less frequent uplink triggers to the STA 302 to reduce upstream transmission rate or using lower MCS (Modulation and Coding Scheme) rate for the STA 302, which will reduce the amount of uplink data received from the STA 302.

Although a specific embodiment for a system 300 illustrating a reverse signaling of upstream congestion in a wireless communication network suitable for carrying out the various steps, processes, methods, and operations described herein is discussed with respect to FIG. 3, any of a variety of systems and/or processes may be utilized in accordance with embodiments of the disclosure. For example, if the STA 302 does not support layer 2 signaling for L4S congestion, then the MAC sublayer at the access point 304 can take other actions to slow down upstream data rate coming from one or more STAs. For example, the access point 304 may reduce uplink resource unit allocation or trigger less resources to some or all of the STAs to slow down the upstream data rate, which can ease the upstream congestion in the LAS queue 324A. The elements depicted in FIG. 3 may also be interchangeable with other elements of FIGS. 1-2 and FIGS. 4-12 as required to realize a particularly desired embodiment.

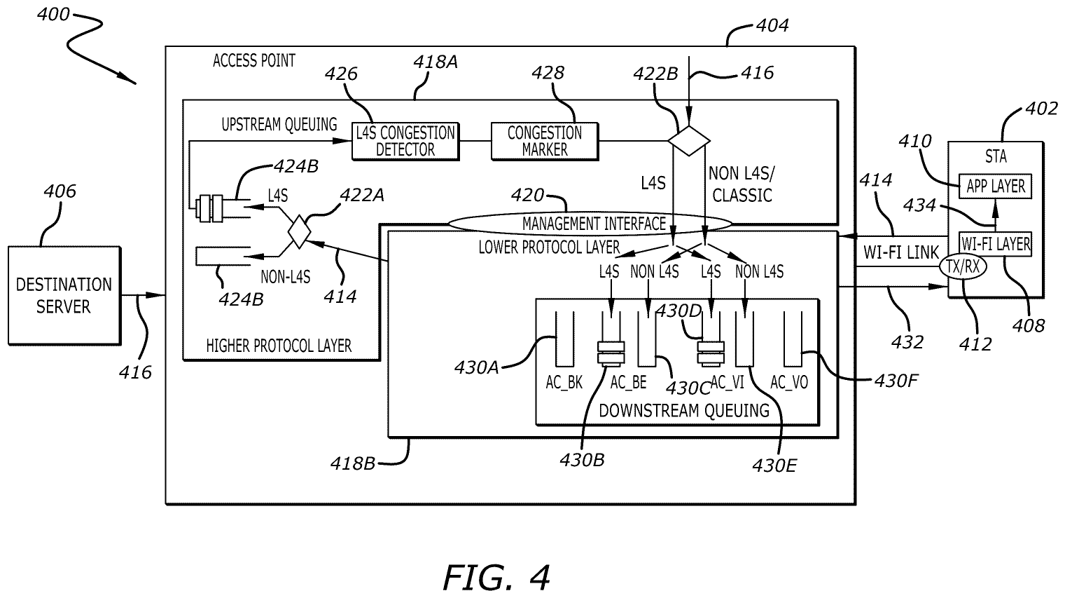

Referring to FIG. 4, a block diagram of a system 400 illustrating a reverse signaling of upstream congestion in a wireless communication network in accordance with various embodiments of the disclosure is shown. Consider an example where a wireless device such as a client device or a station, herein referred to as an “STA 402”, connects to an Access Point (AP) 404 wirelessly using a Wi-Fi® protocol, which may allow the STA 402 to communicate with other devices in the wireless communication network. The access point 404 may be connected to a local network, which in turn, may be connected to the internet or a network device. In some embodiments, the network device can be a server. In some more embodiments, the network device can be an intermediate network node (for example, another access point, a switch, a router, etc.) connecting the access point 404 to the server. In a non-limiting example, the access point 404 is shown to be connected to a destination server 406 in FIG. 4. A Tx/Rx 412 of the STA 402 may transmit first network traffic, for example, LAS traffic, in an upstream direction towards the destination server 406 via the access point 404. The destination server 406 may transmit second network traffic, for example, LAS traffic, in a downstream direction towards the STA 402 via the access point 404.

In the embodiments illustrated in FIG. 4, the access point 404 may implement a higher protocol layer 418A and a lower protocol layer 418B of a network stack defined by an OSI model. In many embodiments, the lower protocol layer 418B may refer to a data link layer or layer 2 including a MAC sublayer. The MAC sublayer may utilize MAC addresses to identify network devices, for example, the STA 402 and the destination server 406, in the wireless communication network. The MAC sublayer may also control how the STA 402 or the destination server 406 accesses and transmits data. The MAC sublayer may be configured to encapsulate data into frames that are transmitted over a wireless communication medium. These frames contain the MAC addresses of both a receiver device and a receiver device. For the first network traffic coming from the STA 402 and flowing in an upstream direction, herein referred to as an “upstream data flow 414”, towards the destination server 406, the STA 402 may be a source device with the access point 404 as the receiver device and the destination server 406 may be the receiver device. For the second network traffic coming from the destination server 406 and flowing in a downstream direction, herein referred to as a “downstream data flow 416”, towards the STA 402, the destination server 406 may be the source device with the access point 404 as the receiver device and the STA 402 may be the receiver device.

In a number of embodiments, the higher protocol layer 418A may include a network layer herein referred to as “layer 3”. The layer 3 may utilize IP addresses to uniquely identify the source device and the destination device and determine an optimal path for data to travel between the source device and the destination device. In a variety of embodiments, the higher protocol layer 418A may include a transport layer herein referred to as “layer 4”. The layer 4 may manage network traffic between the source device and the destination device to ensure complete data transfers. The higher protocol layer 418A may be operably coupled to the lower protocol layer 418B via a management interface 420. The management interface 420 may refer to a structured communication entity that allows exchange of data between the higher protocol layer 418A and the lower protocol layer 418B. The management interface 420 may invoke layer management functions, for example, handing off data packets correctly between the higher protocol layer 418A and the lower protocol layer 418B. In various embodiments, the management interface 420 may be a MAC-SAP. In more embodiments, the management interface 420 may be an MLME. The MLME may communicate with the lower protocol layer 418B, for example, the MAC sublayer, and handle higher-level management functions and decisions that influence the operation of the MAC sublayer. The MLME may also communicate with the higher protocol layer 418A to inform the higher protocol layer 418A about the state of the wireless communication network, any security procedures, or changes in a network topology. In additional embodiments, the higher protocol layer 418A and the lower protocol layer 418B may communicate with each other by exchanging primitives through the management interface 420.

The higher protocol layer 418A may include one or more classifiers, for example, ECN classifiers 422A and 422B. In further embodiments, the ECN classifiers 422A and 422B may be configured to classify network traffic of different types based on DSCP or other packet markings, thereby allowing the ECN classifiers 422A and 422B to apply ECN marking to specific types of network traffic that needs congestion management. The access point 404 may receive an upstream data flow 414 including a plurality of upstream data packets from the STA 402, into the lower protocol layer 418B. In still more embodiments, the ECN classifier 422A in the higher protocol layer 418A may receive the upstream data packets from the lower protocol layer 418B via the management interface 420 and distinguish between LAS data packets and non-LAS data packets by inspecting an ECN field and DSCP in headers of the data packets. The upstream data packets may undergo upstream queuing in the higher protocol layer 418A, where the upstream LAS data packets and the upstream non-LAS data packets are stored in two queues, for example, an LAS queue 424A and a non-LAS queue 424B, respectively, as illustrated in FIG. 4. In still further embodiments, the L4S queue 424A in the higher protocol layer 418A may be a low latency queue configured to store one or more LAS data packets. In still additional embodiments, the non-LAS queue 424B may be a classic queue configured to store one or more non-LAS data packets. In some more embodiments, the ECN classifiers 422A may execute a queuing scheme that prioritizes transmission of the LAS data packets in the LAS queue 424A over the non-L4S data packets in the non-L4S queue 424B. The L4S data packets in the L4S queue 424A may experience upstream congestion, for example, if the STA 402 transmits the LAS data packets at a higher speed than the access point 404 can process and deliver to the destination server 406. In further embodiments, multiple LAS and non-LAS queues may be deployed for different priority levels such as separate queues for best effort, video, or voice priority levels.

In yet various embodiments, the access point 404 may include an LAS congestion detector 426 and a congestion marker 428 implemented in the higher protocol layer 418A. In yet more embodiments, the LAS congestion detector 426 may be operably coupled to the congestion marker 428. In still yet more embodiments, the L4S congestion detector 426 may be configured to detect upstream LAS congestion in the higher protocol layer 418A. In many further embodiments, the L4S congestion detector 426 may be configured to inspect the LAS queue 424A in the higher protocol layer 418A and detect the upstream LAS congestion. In many additional embodiments, the LAS congestion detector 426 may detect the upstream LAS congestion based on queue depth. For example, the LAS congestion detector 426 may continuously inspect the queue depth and detect the upstream LAS congestion if the queue depth is greater than or equal to a threshold count of data packets in the L4S queue 424A. In still yet further embodiments, the L4S congestion detector 426 may configure the threshold count to maximize throughput. In still yet additional embodiments, the L4S congestion detector 426 may employ minimum and maximum queue depth thresholds to detect the upstream LAS congestion.

In several embodiments, based on the detected upstream L4S congestion, the congestion marker 428, in operable communication with the L4S congestion detector 426 in the higher protocol layer 418A, may be configured to perform congestion marking in the required downstream data packets to signal congestion in upstream (reverse direction). The access point 404 may receive the downstream data flow 416 including a plurality of downstream data packets from the destination server 406, through the higher protocol layer 418A. In several more embodiments, to reverse signal the upstream LAS congestion, the congestion marker 428 may mark congestion indication in layer 3, layer 4, or even higher layers of one or more downstream data packets of the downstream data flow 416. For example, the congestion indicator may correspond to one of: one or more bits in an IP Option field of an IPv4 header, one or more bits in a Flags field in the IPv4 header, one or more bits in an Extension header in an IPv6 header, or a specific value in a DSCP field in the IP header.

In numerous embodiments, the congestion marker 428 may be operably coupled to the ECN classifier 422B in the higher protocol layer 418A. The congestion marker 428 may mark the ECN bits in the downstream data packets with 01 to signal these data packets as LAS enabled which then results in these data packets getting queued in LAS queues for prioritized transmission to the STA 402. The ECN classifier 422B may receive the ECN-marked downstream data packets from the congestion marker 428 and distinguish between L4S data packets and non-L4S/classic congestion control data packets by inspecting an ECN field and DSCP in headers of the data packets. These fields indicate whether the downstream data packets should be stored in LAS queues 430B and 430D or non-LAS/classic queues 430C and 430E in the lower protocol layer 418B. In numerous additional embodiments, the L4S queues 430B and 430D in the lower protocol layer 418B may be low latency queues configured to store LAS data packets. In further additional embodiments, the non-LAS queues 430C and 430E may be classic queues configured to store non-LAS data packets. In many embodiments, the ECN classifier 422B may execute a queuing scheme that prioritizes transmission of the L4S data packets in the LAS queues 430B and 430D over the non-LAS data packets in the non-LAS queues 430C and 430E.

The lower protocol layer 418B may receive the downstream data packets from the higher protocol layer 418A via the management interface 420. The downstream data packets may undergo downstream queuing in the lower protocol layer 418B, where the downstream data packets are stored in multiple queues, for example, the queues 430A, 430B, 430C, 430D, 430E, and 430F as illustrated in FIG. 4. The queues 430A, 430B, 430C, 430D, 430E, and 430F are herein collectively referred to as “the queues 430A-430F”. In a number of embodiments, the queues 430A-430F may be defined by ACs, with each access category being associated with a respective priority level. The access categories may include, for example, a BK access category, a BE access category, a VI access category, and a VO access category, denoted as AC_BK, AC_BE, AC_VI, and AC_VO, respectively. By way of a non-limiting example, in a variety of embodiments, the ECN classifier 422B may queue some LAS data packets and non-L4S data packets from the downstream data flow 416 in the queues 430B and 430C, respectively, defined as AC_BE queues, and some L4S data packets and non-L4S data packets in the queues 430D and 430E, respectively, defined as AC_VI queues, as illustrated in FIG. 4.

The embodiments illustrated in FIG. 4 are described in the context of reverse signaling of upstream congestion in a wireless communication network. Consider an example where network traffic from the STA 402 flows in the upstream direction towards the destination server 406. The access point 404 may receive this upstream data flow 414 including multiple upstream data packets from the STA 402. The access point 404 may receive the upstream data flow 414 at the lower protocol layer 418B. In various embodiments, the upstream data flow 414 may be indicative of a source address, for example, a source IP address, associated with the STA 402, and a destination address, for example, a destination IP address, associated with the destination server 406. The ECN classifier 422A in the higher protocol layer 418A may receive the upstream data flow 414 from the lower protocol layer 418B and classify the upstream data packets of the upstream data flow 414 into upstream LAS data packets and upstream non-LAS data packets. In the higher protocol layer 418A, the upstream L4S data packets and the upstream non-L4S data packets are stored in the L4S queue 424A and the non-L4S queue 424B, respectively.

The LAS congestion detector 426 may detect an upstream congestion in the LAS queue 424A. In more embodiments, the LAS congestion detector 426 may determine a count of the upstream LAS data packets in the LAS queue 424A and compare the count of the upstream L4S data packets with a threshold count. The LAS congestion detector 426 may detect the congestion based on the count of the upstream LAS data packets exceeding the threshold count. On detecting the upstream congestion, the LAS congestion detector 426 may transmit a signal to the congestion marker 428 in the higher protocol layer 418A. In the above example, the access point 404 may also receive network traffic flowing in the downstream direction towards the STA 402, coming from the destination server 406. The access point 404 may receive this downstream data flow 416 including multiple downstream data packets, into the higher protocol layer 418A, from the destination server 406. The downstream data flow 416 may be associated with the upstream data flow 414. In additional embodiments, the congestion marker 428 may identify the downstream data flow 416 by determining that the downstream data flow 416 is associated with a source address of the destination server 406 and a destination address of the STA 402. The source address of the destination server 406 and the destination address of the STA 402 may, for example, be IP addresses. The congestion marker 428 may examine the downstream data flow 416 for data packets with reversed source and destination IP addresses, ports, etc., to identify a reverse IP tuple associated with the upstream L4S data packets in the upstream data flow 414.

The congestion marker 428 may then mark one or more of the downstream L4S data packets having the identified reverse IP tuple, that are flowing in the downstream direction, with a congestion indicator, to indicate to the STA 402 that the congestion is experienced in the upstream direction. In further embodiments, the congestion indicator may be indicative of the congestion associated with the upstream data flow 414. For example, the congestion indicator may correspond to one of: one or more bits in an IP Option field of an IPv4 header, one or more bits in a Flags field in the IPv4 header, one or more bits in an Extension header in an IPv6 header, or a specific value in a DSCP field in the IP header. The congestion marker 428 may transmit the marked downstream L4S data packets to the ECN classifier 422B. In response to receiving the marked downstream LAS data packets, the ECN classifier 422B stores the marked downstream LAS data packets into the L4S queues 430B and 430D. The access point 404 may transmit the downstream LAS data packets 432 marked with the congestion indicator to the STA 402. The STA 402 may receive the downstream LAS data packets 432 marked with the congestion indicator via the Tx/Rx 412.

In still further embodiments, the STA 402 may implement a Wi-Fi layer 408 and an application layer 410. The Wi-Fi layer 408 of the STA 402 may include a MAC sublayer configured to perform functions similar to the MAC sublayer of the access point 404 disclosed above. The Wi-Fi layer 408 may handle communication between the STA 402 and the access point 404. The application layer 410 may perform higher-level functions and web application services including, for example, web browsing, transferring files, messaging, etc. The STA 402 may receive the downstream LAS data packets 432 marked with the congestion indicator at the Wi-Fi layer 408 and transmit a feedback signal 434 to the application layer 410 to signal to the application layer 410 to scale down a data rate or a rate of transmitting data to the destination server 406. The STA 402 may then adjust its transmission rate, for example, reduce the transmission rate, in response to the indicated upstream LAS congestion, to reduce the upstream LAS congestion. The devices and methods discussed herein allow the STA 402 to quickly respond to the upstream LAS congestion by allowing transmission of a faster upstream congestion notification to the STA 402 over the lower protocol layer 418B from the access point 404 to the STA 402.

Although a specific embodiment for a reverse signaling of upstream congestion in a wireless communication network suitable for carrying out the various steps, processes, methods, and operations described herein is discussed with respect to FIG. 4, any of a variety of systems and/or processes may be utilized in accordance with various embodiments of the disclosure. For example, in one or more embodiments, the devices and methods discussed herein may employ other different methods and congestion detection algorithms for detecting upstream congestion, for example, by utilizing active probing, flow-level monitoring, deep packet inspection, or the like. The elements depicted in FIG. 4 may also be interchangeable with other elements of FIGS. 1-3 and FIGS. 5-12 as required to realize a particularly desired embodiment.

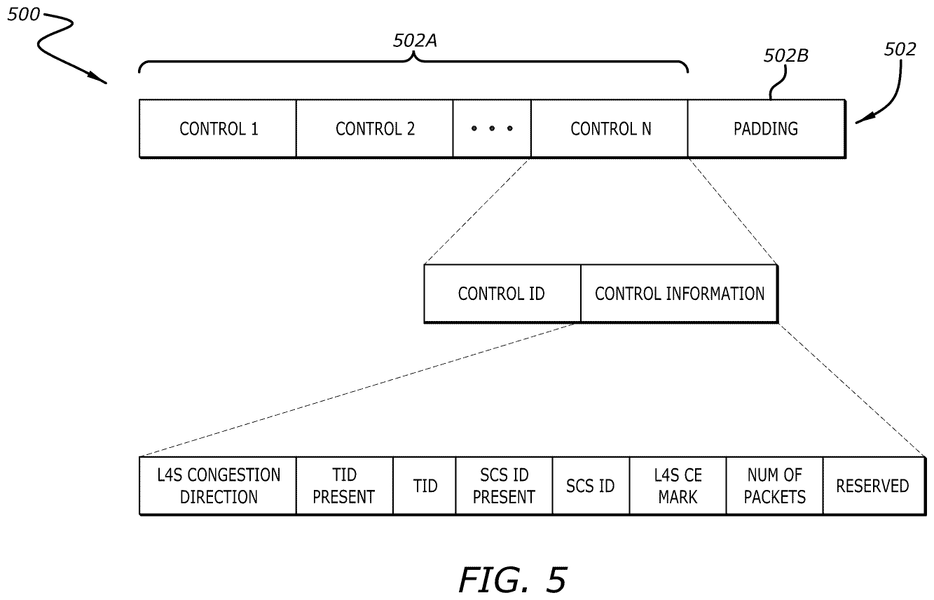

Referring to FIG. 5, a schematic illustration of a control information field format 500 for reverse signaling of congestion in accordance with various embodiments of the disclosure is shown. In many embodiments, the control information field format 500 may be configured to insert a congestion indicator indicative of a congestion associated with a data flow, for example, an upstream LAS data flow. The upstream LAS data flow may come from a wireless device such as a station (STA) and flow in an upstream direction towards a network device such as a destination server. In a number of embodiments, the control information field format 500 may include an A-control subfield 502 of an HE variant HT control field defined to carry layer 2 L4S congestion signaling. The A-control subfield 502 may include a control list 502A with a sequence of one or more control subfields, for example, Control 1, Control 2, . . . , Control N, and a padding subfield 502B. In a variety of embodiments, the control list 502A may extend to a variable number of bits, and the padding subfield 502B may extend to 0 or more bits. Each control subfield may include a control identifier (ID) subfield and a control information subfield. A value in the control ID subfield may indicate an LAS Congestion Indication (LCI). The control information subfield may carry control information that depends on a control ID value indicated in the control ID subfield. The length of control information may depend on the control ID value in the control ID subfield. The padding subfield 502B may follow the last control subfield and may be set to a sequence of zeros to ensure the length of the A-control subfield 502 carried in the HT control field is, for example, 30 bits.

In various embodiments, the control information subfield may include one or more of: an LAS congestion direction subfield, a TID present subfield, a TID subfield, an SCS ID present subfield, an SCS ID subfield, an LAS CE mark subfield, a number of packets subfield, a percentage of packets subfield, a probability of congestion subfield, and/or a reserved subfield. The L4S congestion direction subfield may indicate a direction, for example, an upstream direction or a downstream direction, where the LAS congestion is experienced. For example, the LAS congestion direction subfield may include a value of “1” to indicate the upstream direction where the LAS congestion is experienced at the access point or a value of “0” to indicate a downstream direction where the LAS congestion is experienced at the access point. In more embodiments, the TID may not be present if A-control signaling is carried in a data packet with the same TID. In additional embodiments, the SCS ID may not be present if no SCS stream was established for the L4S upstream data flow. The LAS CE mark subfield may include a value of 1 to indicate congestion is experienced for L4S traffic in the direction indicated by the L4S congestion direction subfield. In further embodiments, the control information subfield may not include the LAS CE Mark when signaling congestion experienced in upstream. The number of packets subfield may indicate the number of upstream data packets that have experienced congestion. For example, a value of 5 in the number of packets subfield may indicate that 5 upstream data packets have experienced congestion at the access point. The percentage of packets subfield may indicate the percentage of upstream data packets that have experienced congestion. For example, a value of 20 in the percentage of packets subfield may indicate that 20% of upstream data packets have experienced congestion at the access point. The probability of congestion subfield may indicate the probability for upstream data packets experiencing congestion. For example, a value of 60 in the probability of congestion subfield may indicate a 60% probability for the upstream data packets to have been experiencing congestion at the access point. In an example, in response to detecting a congestion associated with the upstream LAS data flow, the access point may include the A-control subfield 502 in an MPDU that is part of an ongoing downstream data flow or MPDU of a new QoS null frame. The A-control subfield 502 with the LAS CE mark subfield may indicate the upstream LAS congestion to the STA. In a non-limiting example, the control information subfield in FIG. 5 is shown to include the L4S congestion direction subfield, the TID present subfield, the TID subfield, the SCS ID present subfield, the SCS ID subfield, the LAS CE mark subfield, the number of packets subfield, and the reserved subfield.

Although a specific embodiment for a control information field format 500 for reverse signaling of congestion suitable for carrying out the various steps, processes, methods, and operations described herein is discussed with respect to FIG. 5, any of a variety of systems and/or processes may be utilized in accordance with various embodiments of the disclosure. For example, other formats for the control information subfield in an LAS congestion indication control subfield other than the A-control subfield 502 can be utilized to convey a similar set of parameters. The elements depicted in FIG. 5 may also be interchangeable with other elements of FIGS. 1-4 and FIGS. 6-12 as required to realize a particularly desired embodiment.

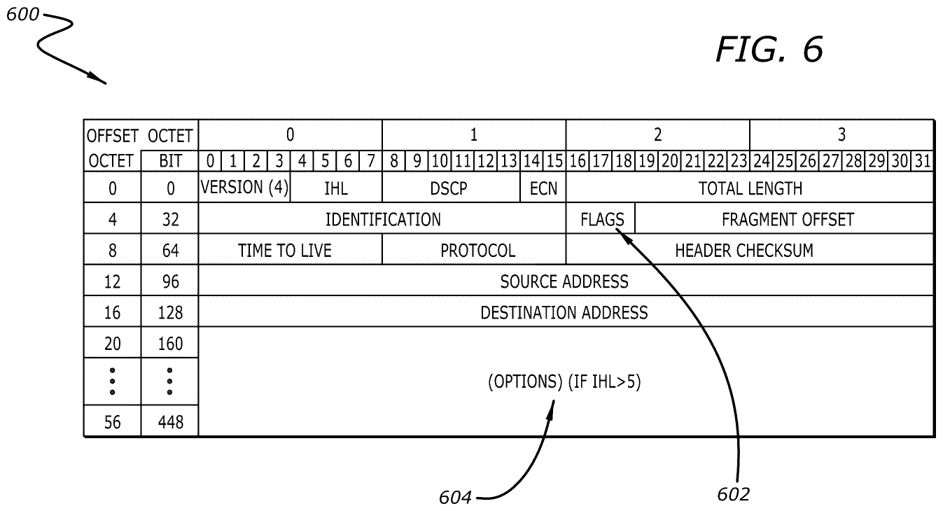

Referring to FIG. 6, a schematic illustration of a format of a header 600 for reverse signaling of congestion in accordance with various embodiments of the disclosure is shown. In many embodiments, if congestion is experienced in a downstream direction at a higher protocol layer, for example, layer 3, in an access point, the access point may signal the congestion in a reverse direction, that is, an upstream direction, to a sender, for example, a destination server, over the layer 3. This reverse signaling of the congestion may transmit the congestion indicator faster to the destination server by transmitting the congestion indicator as part of the upstream data packets that are transmitted to the destination server in the reverse direction. In a number of embodiments, this transmission of the congestion indicator may be performed by employing a field in a layer 3 header of at least one of the upstream data packets that indicates that the congestion was experienced in the downstream direction. The upstream data packet, which is carrying the congestion indicator for the reserve direction, itself has not experienced congestion, but indicates that data packets in the other direction, that is, the downstream data packets, have experienced congestion.

In a variety of embodiments, when the access point detects a downstream LAS congestion, the access point may add an IP option field 604 in the header 600 of at least one upstream data packet, including a “Congestion Experienced in reverse direction” option. The header 600 may, for example, be an IPv4 header. The IP option field 604 in the header 600 of at least one upstream data packet flowing in the upstream direction may indicate the congestion is experienced in the reverse direction, that is, in the downstream direction. In various embodiments, the access point may utilize one of the reserved bits in a Flags field 602 in the header 600 of at least one upstream data packet to indicate the congestion experienced in the reverse direction, that is, to indicate the downstream L4S congestion. For an IP version 6 (IPv6) header, in more embodiments, a new extension header can be defined that indicates the congestion experienced in the reverse direction. In one embodiment, a specific DSCP value (e.g. DSCP value 63 with all 6 bits set to 1) in an IP header can be used as a congestion indicator to indicate congestion in the reverse direction.

Similarly, in additional embodiments, when the access point detects an upstream LAS congestion, the access point may add an IP option field 604 in the header 600 of at least one downstream data packet, including a “Congestion Experienced in reverse direction” option. The IP option field 604 in the header 600 of at least one downstream data packet flowing in the downstream direction towards an STA may indicate the congestion is experienced in the reverse direction, that is, in the upstream direction. In further embodiments, the access point may utilize one of the reserved bits in a Flags field 602 in the header 600 of at least one downstream data packet to indicate the congestion experienced in the reverse direction, that is, to indicate the upstream LAS congestion. When the STA receives signaling that indicates the congestion experienced in the reverse direction, the STA may determine that the congestion was experienced in the opposite direction of the received downstream data packet, thereby indicating that the congestion was experienced in the upstream data flow transmitted by the STA. The STA can then reduce its data rate to ease the congestion.

In still more embodiments, the access point can signal their capability for supporting LAS congestion indication in the reverse direction for downstream and/or upstream data flows. The downstream data flows may include downlink (DL) traffic, and the upstream data flows may include uplink (UL) traffic. For UL traffic, the access point can indicate its capability to support for layer 2 signaling for indicating upstream congestion. In still further embodiments, the upstream congestion may be signaled in 802.11bn as part of Ultra High Reliability (UHR) capabilities or another element/field. In still additional embodiments, the access point may signal these capabilities in management frames such as beacon, probe response, and (re) association response, or another management frame. The STA may indicate support for receiving layer 2 signaling that indicates congestion in the upstream direction and responding to the indication by applying a back pressure to an application to reduce the UL data rate. In some more embodiments, the STA may signal this capability in management frames such as (re) association request or another management frame.

Although a specific embodiment for a format of a header 600 for reverse signaling of congestion suitable for carrying out the various steps, processes, methods, and operations described herein is discussed with respect to FIG. 6, any of a variety of systems and/or processes may be utilized in accordance with various embodiments of the disclosure. For example, in yet various embodiments, “Congestion Experienced in reverse direction” may be indirectly signaled by utilizing other fields of the header 600 such as a Time-To-Live (TTL) field. To signal the degree of congestion experienced by data packets flowing in a one direction, the access point may adjust the TTL of at least one data packet flowing in a reverse direction. A data packet may be dropped or altered in specific ways based on network congestion, which could indirectly result in a reduction in the TTL before the data packet reaches its destination. The elements depicted in FIG. 6 may also be interchangeable with other elements of FIGS. 1-5 and FIGS. 7-12 as required to realize a particularly desired embodiment.

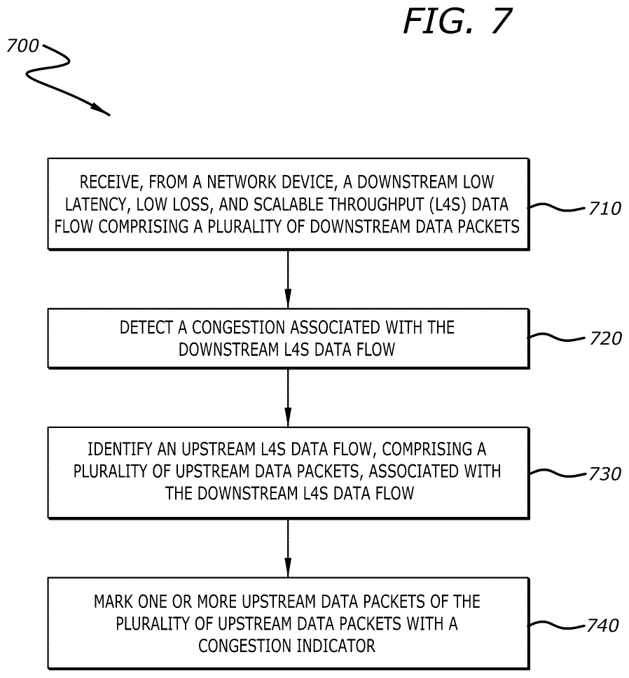

Referring to FIG. 7, a flowchart depicting a process 700 for reverse signaling of downstream congestion in accordance with various embodiments of the disclosure is shown. In many embodiments, the process 700 may receive, from a network device, a downstream L4S data flow comprising a plurality of downstream data packets (block 710). In a number of embodiments, the process 700 may be implemented at an access point in a wireless communication network. The network device may be a server, for example, a destination server such as a cloud server, configured to transmit data packets in a downstream direction to a wireless device in the wireless communication network. The wireless device may be a station (herein referred to as an “STA”) including, for example, end-user devices or client devices such as laptops, tablets, smartphones, gaming consoles, mobile stations, personal digital assistants, wearable devices, or the like. The downstream L4S data flow may refer to L4S data packets coming from the network device and flowing in the downstream direction towards the wireless device. In a variety of embodiments, the downstream L4S data flow may be indicative of real-time or near-real time data. In various embodiments, the downstream LAS data flow can be indicative of high priority data or latency sensitive data. In more embodiments, the downstream LAS data flow may be addressed to the wireless device.

The access point may receive the downstream LAS data flow from the network device. In additional embodiments, the process 700 may receive the downstream LAS data flow at a higher protocol layer, for example, layer 3 or layer 4, of the access point. In further embodiments, the downstream LAS data flow may be indicative of a source address associated with the network device and a destination address associated with the wireless device. In still more embodiments, the process 700 may determine an IP tuple associated with the downstream LAS data flow. The IP tuple can be indicative of source and destination IP addresses, source and destination port numbers, or protocols, etc., associated with the downstream LAS data flow. In still further embodiments, the process 700 may execute a queuing scheme for classifying the downstream data packets in the downstream LAS data flow into downstream LAS data packets and accordingly, queuing the downstream LAS data packets into L4S queues in a lower protocol layer, for example, a MAC sublayer, of the access point.

In still additional embodiments, the process 700 may detect a congestion associated with the downstream LAS data flow (block 720). In some more embodiments, the process 700 may detect the congestion associated with the downstream LAS data flow based on queue depth. For example, the process 700 may continuously inspect the queue depth and, if the queue depth is greater than or equal to a threshold count of downstream L4S data packets in the LAS queues, the process 700 may detect the congestion associated with the downstream L4S data flow. In yet various embodiments, the process 700 may configure the threshold count to maximize throughput. In yet more embodiments, the process 700 may employ minimum and maximum queue depth thresholds to detect the congestion associated with the downstream L4S data flow.

In still yet more embodiments, the process 700 may identify an upstream L4S data flow, comprising a plurality of upstream data packets, associated with the downstream LAS data flow (block 730). For example, the process 700 may receive one or more upstream LAS data flows, and from these upstream LAS data flows, the process 700 may identify one such upstream LAS data flow that is associated with the downstream LAS data flow. The identified upstream LAS data flow may refer to LAS data packets coming from the wireless device and flowing in an upstream direction towards the network device that is generating the downstream L4S data flow associated with the detected congestion. To identify the upstream LAS data flow, in many further embodiments, the process 700 may receive the upstream LAS data flow from the wireless device; and determine that the upstream LAS data flow is associated with a source address associated with the wireless device and a destination address associated with the network device. In many additional embodiments, the process 700 may determine an upstream L4S data flow associated with a reverse IP tuple, that is, the upstream L4S data flow where the source and destination IP addresses and/or source and destination port numbers may be reversed.

In still further embodiments, the process 700 may mark one or more upstream data packets of the plurality of upstream data packets with a congestion indicator (block 740). In still additional embodiments, the congestion indicator may be indicative of the congestion associated with the downstream L4S data flow. In many further embodiments, the congestion indicator may be marked in one of a Layer 3 header or a higher layer header than the Layer 3 header of the one or more upstream LAS data packets to indicate the congestion in the downstream direction. For example, the congestion indicator may correspond to one of: one or more bits in an IP Option field of an IPv4 header, one or more bits in a Flags field in the IPv4 header, one or more bits in an Extension header in an IPv6 header, or a specific value in a DSCP field in the IP header. In many further embodiments, the process 700 may further mark the one or more of the upstream LAS data packets as L4S enabled data packets by setting ECN bits to 01 in the IP header.

Although a specific embodiment for a high-level process 700 for reverse signaling of downstream congestion suitable for carrying out the various steps, processes, methods, and operations described herein is discussed with respect to FIG. 7, any of a variety of systems and/or processes may be utilized in accordance with embodiments of the disclosure. For example, instead of detection of the downstream congestion at the access point, the network device may be configured to detect the downstream congestion by utilizing different methods such as calculating round-trip times between transmitting requests and receiving acknowledgments and determining higher round-trip times, monitoring throughput against historical averages, etc. The elements depicted in FIG. 7 may also be interchangeable with other elements of FIGS. 1-6 and FIGS. 8-12 as required to realize a particularly desired embodiment.

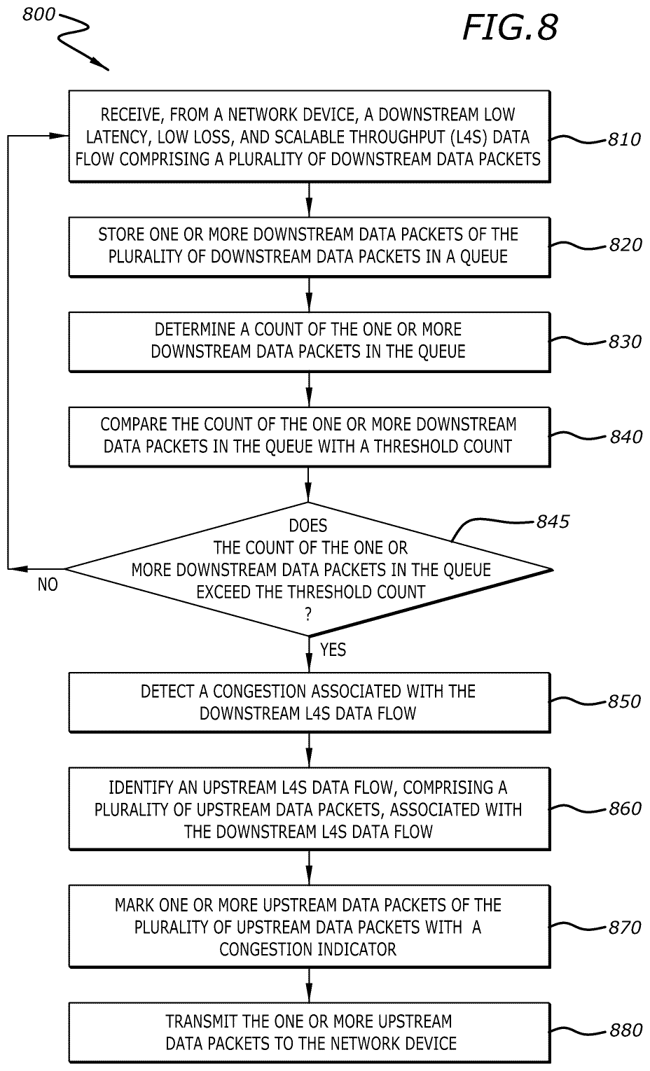

Referring to FIG. 8, a flowchart depicting a process 800 for reverse signaling of downstream congestion in accordance with various embodiments of the disclosure is shown. In many embodiments, the process 800 may receive, from a network device, a downstream L4S data flow comprising a plurality of downstream data packets (block 810). In a number of embodiments, the process 800 may be implemented at an access point in a wireless communication network. The downstream LAS data flow may refer to LAS data packets coming from the network device and flowing in a downstream direction towards a wireless device in the wireless communication network. The access point may receive the downstream L4S data flow from the network device. In a variety of embodiments, the process 800 may receive the downstream L4S data flow at a higher protocol layer, for example, layer 3 or layer 4, of the access point. In various embodiments, the downstream L4S data flow may be indicative of a source address associated with the network device and a destination address associated with the wireless device. In more embodiments, the process 800 may determine an IP tuple associated with the downstream LAS data flow. The IP tuple can be indicative of source and destination IP addresses, source and destination port numbers, or protocols, etc., associated with the downstream L4S data flow.

In additional embodiments, the process 800 may store one or more downstream data packets of the plurality of downstream data packets in a queue (block 820). In further embodiments, the process 800 may employ an ECN classifier for classifying the downstream data packets in the downstream LAS data flow into downstream LAS data packets. The process 800 may then execute a queuing scheme to queue the downstream LAS data packets into one or more LAS queues. In still more embodiments, the process 800 may store the downstream L4S data packets in one or more L4S queues in a lower protocol layer, for example, a MAC sublayer, of the access point. In still further embodiments, the L4S queues may be defined by Access Categories (ACs), with each access category being associated with a respective priority level. By way of a non-limiting example, in still additional embodiments, the ECN classifier may queue some LAS data packets from the downstream data flow in an L4S queue defined as an AC_BE queue, and some LAS data packets in an LAS queue defined as an AC_VI queue, where AC_BE may refer to a Best Effort (BE) access category and AC_VI may refer to a video (VI) access category.

In some more embodiments, the process 800 may determine a count of the one or more downstream data packets in the queue (block 830). The process 800 may continuously inspect and count the number of L4S data packets stored in the L4S queues to determine a queue depth. The LAS queues may be dedicated hardware buffers utilized for storing the L4S data packets. In yet various embodiments, the process 800 may determine the count of the L4S data packets stored in the LAS queues by accessing the L4S queues through specialized driver interfaces or hardware performance counters. These driver interfaces or hardware performance counters may allow the lower protocol layer, for example, the MAC sublayer, to query the number of L4S data packets stored in the LAS queues. In yet more embodiments, the process 800 may determine a queue depth by accessing a data structure that stores the L4S data packets awaiting transmission.

In still yet more embodiments, the process 800 may compare the count of the one or more downstream data packets in the queue with a threshold count (block 840). The threshold count may refer to a threshold number of downstream data packets, for example, the LAS data packets, set by the access point for detecting a congestion. The process 800 may determine the threshold count associated with each LAS queue. In many further embodiments, the process 800 may determine the threshold count based on one or more of: a type of the L4S data packets, priority of the LAS data packets, Quality of Service (QOS) parameters of the L4S data packets, etc. In many additional embodiments, the process 800 can dynamically change or modify the threshold count based on network conditions, network demand, QoS requirements, etc. In still yet further embodiments, the threshold count may be predetermined for different types of L4S queues defined by access categories including, for example, the BE access category, the VI access category, or the like. In still yet additional embodiments, the threshold count may be configurable by an operator. In several embodiments, the threshold count can be different for different LAS data flows associated with different applications implemented by the same wireless device. The process 800 may continuously or periodically count the number of LAS data packets in the LAS queues and compare this count with the threshold count.

In several more embodiments, the process 800 may determine whether the count of the one or more downstream data packets in the queue exceeds the threshold count (block 845). The process 800 may continuously or periodically determine whether the count of the downstream data packets, for example, the L4S data packets in the L4S queues exceeds the threshold count. In numerous embodiments, the process 800 may employ an interrupt-driven mechanism or periodic polling, depending on a design of the access point and management of its resources, to determine whether the count of the L4S data packets in each LAS queue exceeds the threshold count. If the count of the L4S packets in each LAS queue exceeds the threshold count, the process 800 may execute different actions depending on the specific configuration. In scenarios where the access point is managing traffic based on QoS, the process 800 may compare the packet count of different access categories (e.g., voice, video, best-effort). If one access category exceeds its threshold count, the process 800 may prioritize higher-priority traffic (e.g., voice packets) over others (e.g., data packets).

In response to determining that the count of the one or more downstream data packets in the queue exceeds the threshold count, in numerous additional embodiments, the process 800 may detect a congestion associated with the downstream LAS data flow (block 850). In further additional embodiments, the process 800 may detect the congestion based on the count of the downstream data packets, for example, the LAS data packets, exceeding the threshold count. If the L4S data packets are delayed due to waiting in the L4S queues for a long time, it suggests that the congestion associated with the downstream LAS data flow, herein referred to as “downstream LAS congestion”, is being experienced at the access point. The process 800 may track and report the count of the L4S data packets waiting in the LAS queues to allow the detection of the downstream LAS congestion.

In many embodiments, the process 800 may identify an upstream LAS data flow, comprising a plurality of upstream data packets, associated with the downstream LAS data flow (block 860). For example, the process 800 may receive one or more upstream L4S data flows, and from these upstream L4S data flows, the process 800 may identify one such upstream LAS data flow that is associated with the downstream LAS data flow. The upstream L4S data flow may refer to LAS data packets coming from the wireless device and flowing in an upstream direction towards the network device. To identify the upstream LAS data flow, in a number of embodiments, the process 800 may receive the upstream LAS data flow from the wireless device; and determine that the upstream L4S data flow is associated with a source address associated with the wireless device and a destination address associated with the network device. In a variety of embodiments, the process 800 may determine an upstream L4S data flow associated with a reverse IP tuple, that is, the upstream LAS data flow where the source and destination IP addresses and/or source and destination port numbers may be reversed.

In various embodiments, the process 800 may mark one or more upstream data packets of the plurality of upstream data packets with a congestion indicator (block 870). In more embodiments, the congestion indicator may be indicative of the downstream L4S congestion. In many further embodiments, the congestion indicator may be marked in one of a Layer 3 header or a higher layer header than the Layer 3 header of the one or more upstream L4S data packets to indicate the congestion in the downstream direction. For example, the congestion indicator may correspond to one of: one or more bits in an IP Option field of an IPv4 header, one or more bits in a Flags field in the IPv4 header, one or more bits in an Extension header in an IPv6 header, or a specific value in a DSCP field in the IP header. In many further embodiments, the process 800 may further mark the one or more of the upstream LAS data packets as LAS enabled data packets by setting ECN bits to 01 in the IP header . . .

In further embodiments, the process 800 may transmit the one or more upstream data packets to the network device (block 880). The process 800 may transmit the upstream data packets marked with the congestion indicator to the network device. In some embodiments, the network device may be an application server that is generating the downstream L4S data flow associated with the detected congestion. In some more embodiments, the network device may be an intermediate device in an upstream path leading to the application server from the access point. The marking of the one or more upstream data packets with ECN=01 and the congestion indicator may signal the downstream LAS congestion to the network device without causing significant delays. To reduce the downstream LAS congestion, the network device may, for example, reduce the transmission rate.

However, in response to determining that the count of the one or more downstream data packets in the queue does not exceed the threshold count, in still more embodiments, the process 800 may proceed to receive, from the network device, a downstream LAS data flow comprising a plurality of downstream data packets (block 810) and repeat the process 800. In still further embodiments, the count of the downstream data packets in the L4S queues not exceeding the threshold count may indicate there is no downstream LAS congestion. The queue depth or the count of the downstream data packets in the LAS queues being consistently below the threshold count indicates that there is no downstream L4S congestion. When the LAS queues are not overflowing and the number of downstream data packets waiting is within the threshold count, it means the access point can handle the incoming traffic, suggesting no downstream LAS congestion.

Although a specific embodiment for a low-level process 800 for reverse signaling of downstream congestion suitable for carrying out the various steps, processes, methods, and operations described herein is discussed with respect to FIG. 8, any of a variety of systems and/or processes may be utilized in accordance with embodiments of the disclosure. For example, in still additional embodiments, for Wi-Fi, the process 800 may detect the downstream LAS congestion based on a Received Signal Strength Indicator (RSSI) of the wireless device. For example, if the RSSI of the wireless device is poor, the process 800 may transmit a signal to the access point to mark more or all data packets for the downstream LAS congestion as the likelihood of delivering data packets is lower. In another example, if the RSSI of the wireless device is good, the process 800 may transmit a signal to the access point to mark less data packets for the downstream LAS congestion since likelihood of delivering the data packets (without requiring retries) is higher. The elements depicted in FIG. 8 may also be interchangeable with other elements of FIGS. 1-7 and FIGS. 9-12 as required to realize a particularly desired embodiment.

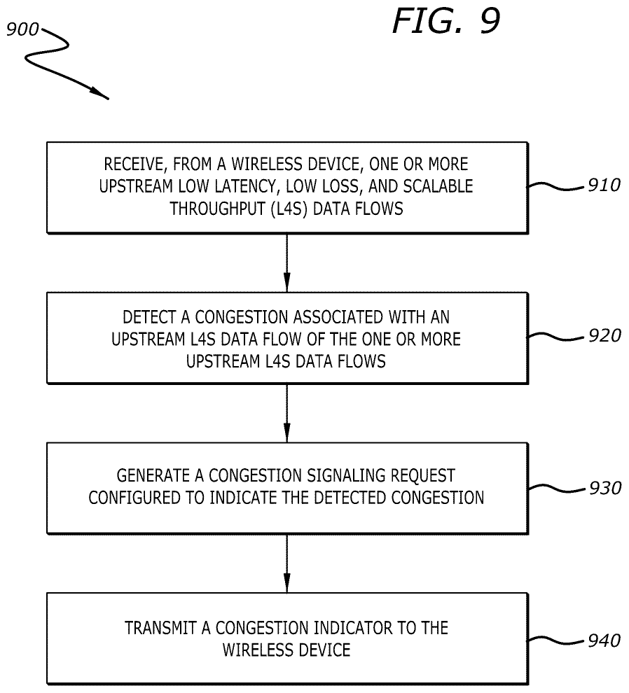

Referring to FIG. 9, a flowchart depicting a process 900 for reverse signaling of upstream congestion in accordance with various embodiments of the disclosure is shown. In many embodiments, the process 900 may receive, from a wireless device, one or more upstream L4S data flows (block 910). In a number of embodiments, the process 900 may be implemented at an access point in a wireless communication network. The wireless device may be a station (herein referred to as an “STA”) including, for example, end-user devices or client devices such as laptops, tablets, smartphones, gaming consoles, mobile stations, personal digital assistants, wearable devices, or the like. An upstream L4S data flow may refer to LAS data packets coming from the wireless device and flowing in an upstream direction towards a network device. The network device may be a server, for example, a destination server such as a cloud server, configured to receive data packets flowing in the upstream direction to the wireless device in the wireless communication network. The access point may receive the one or more upstream L4S data flows from the wireless device. The access point may receive the one or more upstream LAS data flow at a higher protocol layer, for example, layer 3 or layer 4, of the access point.

In a variety of embodiments, the process 900 may detect a congestion associated with an upstream LAS data flow of the one or more upstream LAS data flows (block 920). In various embodiments, the process 900 may detect the congestion (herein referred to as “upstream L4S congestion”) associated with the upstream LAS data flow comprising a plurality of upstream data packets based on a queue depth. For example, the process 900 may continuously inspect the queue depth and, if the queue depth is greater than or equal to a threshold count of upstream L4S data packets in an LAS queue, the process 900 may detect the upstream LAS congestion. In more embodiments, the process 900 may configure the threshold count to maximize throughput. In additional embodiments, the process 900 may employ minimum and maximum queue depth thresholds to detect the upstream L4S congestion. In further embodiments, the process 900 may detect the upstream LAS congestion at an egress point of the access point on a data path to the network device.

In still more embodiments, the process 900 may generate a congestion signaling request configured to indicate the detected congestion (block 930). In still further embodiments, the process 900 may generate a southbound primitive labeled, for example, “L4S-CONG-SIGNAL.request” primitive, as the congestion signaling request. The process 900 may generate the congestion signaling request at a management interface, for example, a MAC-SAP or an MLME, between the higher protocol layer and a lower protocol layer such as the MAC sublayer, to indicate an upstream L4S congestion is experienced in the L4S queue at the access point. In still additional embodiments, the congestion signaling request may request the MAC sublayer to transmit L2 signaling for the upstream L4S congestion to the wireless device. In response, the MAC sublayer may transmit an LAS congestion experienced signal over L2 signaling to the wireless device. In some more embodiments, the congestion signaling request may include at least one of: a priority of one or more upstream LAS data packets associated with the upstream L4S congestion; an identifier of the upstream L4S data packets; an indication of a direction of the detected congestion, for example, the upstream direction; or a count of the upstream LAS data packets. In yet various embodiments, in response to receiving the congestion signaling request from the higher protocol layer, the access point may execute actions, for example, to allocate less resources to one or more wireless devices for uplink so that overall uplink throughput is reduced, which eases the upstream LAS congestion eventually.

In yet more embodiments, the process 900 may transmit a congestion indicator to the wireless device (block 940). The process 900 may transmit the congestion indicator to the wireless device based on the generated congestion signaling request. In still yet more embodiments, the congestion indicator may be indicative of the upstream LAS congestion. In many further embodiments, the process 900 may transmit the congestion indicator to the wireless device as follows. The process 900 may generate an MPDU including a congestion indication control field in a MAC header, and then transmit the MPDU to the wireless device. In many additional embodiments, the congestion indication control field may include a value, for example, “1”, indicative of the upstream LAS congestion. In still yet further embodiments, the congestion indication control field may be a separate LCI control subfield defined in the MPDU, which can be utilized to signal the upstream LAS congestion to the wireless device. In still yet additional embodiments, the process 900 may transmit the congestion indicator to the wireless device in at least one of a downstream data packet having the destination address of the wireless device, a QoS null frame, or a management frame.

Although a specific embodiment for the high-level process 900 for reverse signaling of upstream congestion suitable for carrying out the various steps, processes, methods, and operations described herein is discussed with respect to FIG. 9, any of a variety of systems and/or processes may be utilized in accordance with embodiments of the disclosure. For example, instead of detection of the upstream LAS congestion at the access point, the wireless device may be configured to detect the upstream LAS congestion by utilizing different methods such as measuring round-trip times through ping or traceroute commands, monitoring retransmission behavior, monitoring throughput and change in TCP window size, etc. The elements depicted in FIG. 9 may also be interchangeable with other elements of FIGS. 1-8 and FIGS. 10-12 as required to realize a particularly desired embodiment.

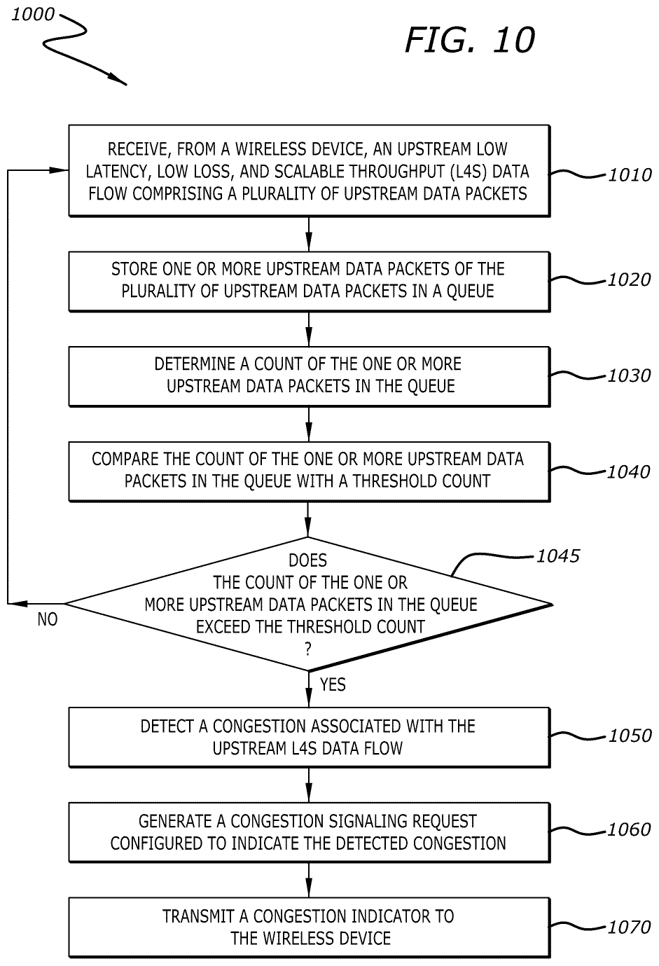

Referring to FIG. 10, a flowchart depicting a process 1000 for reverse signaling of upstream congestion in accordance with various embodiments of the disclosure is shown. In many embodiments, the process 1000 may receive, from a wireless device, an upstream L4S data flow comprising a plurality of upstream data packets (block 1010). In a number of embodiments, the process 1000 may be implemented at an access point in a wireless communication network. The upstream L4S data flow may refer to LAS data packets coming from the wireless device and flowing in an upstream direction towards a network device in the wireless communication network. The access point may receive the upstream LAS data flow from the wireless device. The access point may receive the upstream L4S data flow at a higher protocol layer, for example, layer 3 or layer 4, of the access point.

In a variety of embodiments, the process 1000 may store one or more upstream data packets of the plurality of upstream data packets in a queue (block 1020). In various embodiments, the process 1000 may employ an ECN classifier for classifying the upstream data packets in the upstream LAS data flow into upstream LAS data packets. The process 1000 may then execute a queuing scheme to queue the upstream L4S data packets into one or more L4S queues. In more embodiments, the process 1000 may store the upstream LAS data packets in one or more LAS queues in the higher protocol layer of the access point.

In additional embodiments, the process 1000 may determine a count of the one or more upstream data packets in the queue (block 1030). The process 1000 may continuously inspect and count the number of L4S data packets stored in the L4S queue(s) to determine a queue depth. The LAS queue(s) may be dedicated hardware buffers utilized for storing the L4S data packets. In further embodiments, the process 1000 may determine the count of the LAS data packets stored in the L4S queue(s) by accessing the L4S queue(s) through specialized driver interfaces or hardware performance counters. These driver interfaces or hardware performance counters may allow the higher protocol sublayer to query the number of LAS data packets stored in the L4S queue(s). In still more embodiments, the process 1000 may determine a queue depth by accessing a data structure that stores the LAS data packets awaiting transmission.

In still further embodiments, the process 1000 may compare the count of the one or more upstream data packets in the queue with a threshold count (block 1040). The threshold count may refer to a threshold number of upstream data packets, for example, the L4S data packets, set by the access point for detecting a congestion. The process 1000 may determine the threshold count associated with the LAS queue(s). In still additional embodiments, the process 1000 may determine the threshold count based on one or more of: a type of the L4S data packets, priority of the LAS data packets, Quality of Service (QOS) parameters of the L4S data packets, etc. In some more embodiments, the process 1000 can dynamically change or modify the threshold count based on network conditions, network demand, QoS requirements, etc. In yet various embodiments, the threshold count may be predetermined for different types of LAS queues defined by access categories including, for example, the BE access category, the VI access category, or the like. In yet more embodiments, the threshold count may be configurable by an operator. In still yet more embodiments, the threshold count can be different for different LAS data flows associated with different applications implemented by the same wireless device. The process 1000 may continuously or periodically count the number of LAS data packets in the LAS queue(s) and compare this count with the threshold count.

In many further embodiments, the process 1000 may determine whether the count of the one or more upstream data packets in the queue exceeds the threshold count (block 1045). The process 1000 may continuously or periodically determine whether the count of the upstream data packets, for example, the LAS data packets in the LAS queue(s) exceeds the threshold count. In many additional embodiments, the process 1000 may employ an interrupt-driven mechanism or periodic polling, depending on a design of the access point and management of its resources, to determine whether the count of the L4S data packets in the LAS queue(s) exceeds the threshold count. If the count of the LAS packets in the LAS queue(s) exceeds the threshold count, the process 1000 may execute different actions depending on the specific configuration.

In response to determining the count of the one or more upstream data packets in the queue exceeds the threshold count, in still yet further embodiments, the process 1000 may detect a congestion associated with the upstream L4S data flow (block 1050). In still yet additional embodiments, the process 1000 may detect the congestion at the access point based on the count of the upstream data packets, for example, the LAS data packets, exceeding the threshold count. If the L4S data packets are delayed due to waiting in the queue for a long time, it suggests that the congestion associated with the upstream LAS data flow, herein referred to as “upstream LAS congestion”, is being experienced at the access point. The process 1000 may track and report the count of the LAS data packets waiting in the LAS queue(s) to allow the detection of the upstream L4S congestion.

In several embodiments, the process 1000 may generate a congestion signaling request configured to indicate the detected congestion (block 1060). In several more embodiments, the process 1000 may generate a southbound primitive labeled, for example, “L4S-CONG-SIGNAL.request” primitive, as the congestion signaling request. The process 1000 may generate the congestion signaling request at a management interface, for example, a MAC-SAP or an MLME, between the higher protocol layer and a lower protocol layer such as the MAC sublayer, to indicate the upstream LAS congestion is experienced in the LAS queue(s) at the access point. The congestion signaling request may request the MAC sublayer to transmit L2 signaling for the upstream LAS congestion to the wireless device. In response, the MAC sublayer may transmit an LAS congestion experienced signal over L2 signaling to the wireless device. In numerous embodiments, the congestion signaling request may include at least one of: a priority of one or more upstream LAS data packets associated with the upstream LAS congestion; an identifier of the upstream LAS data packets; an indication of a direction of the detected congestion, for example, the upstream direction; a count of the upstream LAS data packets; a percentage of the upstream L4S data packets that experienced congestion; or a probability of congestion experienced in the upstream.

In numerous additional embodiments, the process 1000 may transmit a congestion indicator to the wireless device (block 1070). The process 1000 may transmit the congestion indicator to the wireless device based on the generated congestion signaling request. In further additional embodiments, the congestion indicator may be indicative of the upstream LAS congestion. In many embodiments, the process 1000 may transmit the congestion indicator to the wireless device as follows. The process 1000 may generate an MPDU including a congestion indication control field in a MAC header, and then transmit the MPDU to the wireless device. In a number of embodiments, the congestion indication control field may include a value, for example, “1”, indicative of the upstream LAS congestion. In a variety of embodiments, the congestion indication control field may be a separate LCI control subfield defined in the MPDU, which can be utilized to signal the upstream LAS congestion to the wireless device. In various embodiments, the process 1000 may transmit the congestion indicator to the wireless device in at least one of a downstream data packet having the destination address of the wireless device, a QoS null frame, or a management frame.

However, in response to determining the count of the one or more upstream data packets in the queue does not exceed the threshold count, in more embodiments, the process 1000 may proceed to receive, from the wireless device, an upstream LAS data flow comprising a plurality of upstream data packets (block 1010) and repeat the process 1000. In additional embodiments, the count of the upstream data packets in the queue not exceeding the threshold count may indicate there is no upstream L4S congestion. The queue depth or the count of the upstream data packets in the queue being consistently below the threshold count indicates that there is no upstream LAS congestion. When the LAS queue(s) is not overflowing and the number of upstream data packets waiting is within the threshold count, it means the access point can handle the incoming traffic, suggesting no upstream LAS congestion.

Although a specific embodiment for a low-level process 1000 for reverse signaling of upstream congestion suitable for carrying out the various steps, processes, methods, and operations described herein is discussed with respect to FIG. 10, any of a variety of systems and/or processes may be utilized in accordance with embodiments of the disclosure. For example, in further embodiments, the threshold count can be optimized based on network requirements by utilizing empirical tuning or Machine Learning (ML) techniques. The elements depicted in FIG. 10 may also be interchangeable with other elements of FIGS. 1-9 and FIGS. 11-12 as required to realize a particularly desired embodiment.

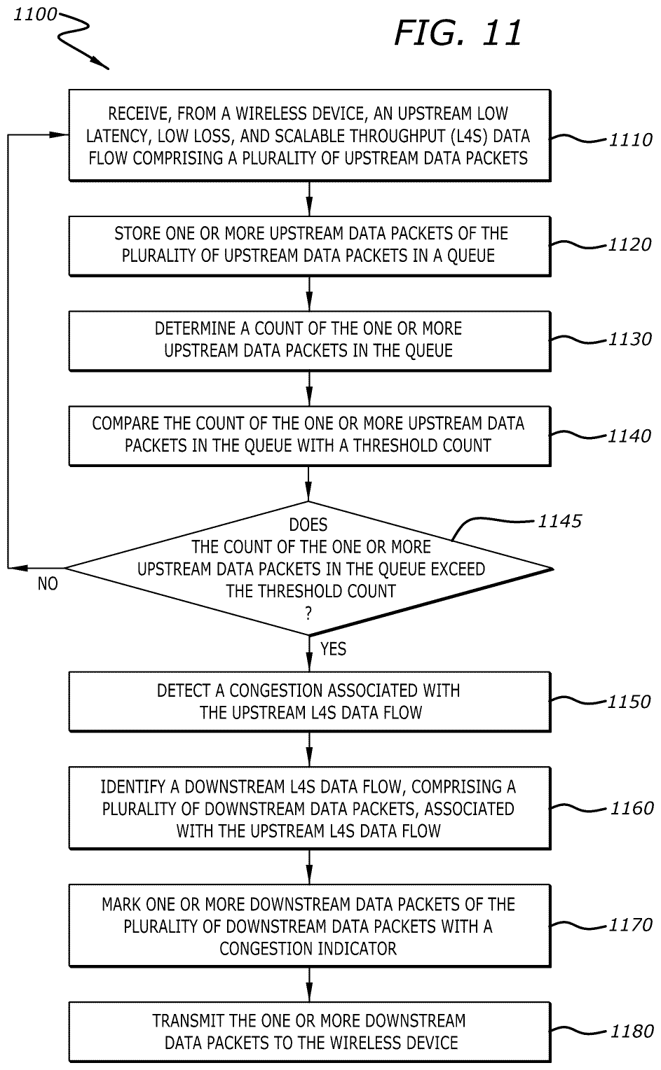

Referring to FIG. 11, a flowchart depicting a process 1100 for reverse signaling of upstream congestion in accordance with various embodiments of the disclosure is shown. In many embodiments, the process 1100 may receive, from a wireless device, an upstream LAS data flow comprising a plurality of upstream data packets (block 1110). In a number of embodiments, the process 1100 may be implemented at an access point in a wireless communication network. The upstream L4S data flow may refer to L4S data packets coming from the wireless device and flowing in an upstream direction towards a network device in the wireless communication network. The access point may receive the upstream L4S data flow from the wireless device. The access point may receive the upstream LAS data flow at a higher protocol layer, for example, layer 3 or layer 4, of the access point. In a variety of embodiments, the upstream LAS data flow may be indicative of a source address associated with the wireless device and a destination address associated with the network device. In various embodiments, the process 1100 may determine an IP tuple associated with the upstream LAS data flow. The IP tuple can be indicative of source and destination IP addresses, source and destination port numbers, or protocols, etc., associated with the upstream LAS data flow.

In more embodiments, the process 1100 may store one or more upstream data packets of the plurality of upstream data packets in a queue (block 1120). In additional embodiments, the process 1100 may employ an ECN classifier for classifying the upstream data packets in the upstream LAS data flow into upstream LAS data packets. The process 1100 may then execute a queuing scheme to queue the upstream LAS data packets into one or more L4S queues. In further embodiments, the process 1100 may store the upstream LAS data packets in one or more LAS queues in the higher protocol layer of the access point.

In still more embodiments, the process 1100 may determine a count of the one or more upstream data packets in the queue (block 1130). The process 1100 may continuously inspect and count the number of L4S data packets stored in the LAS queue(s) to determine a queue depth. The L4S queue(s) may be dedicated hardware buffers utilized for storing the L4S data packets. In still further embodiments, the process 1100 may determine the count of the LAS data packets stored in the LAS queue(s) by accessing the L4S queue(s) through specialized driver interfaces or hardware performance counters. These driver interfaces or hardware performance counters may allow the higher protocol sublayer to query the number of L4S data packets stored in the LAS queue(s). In still additional embodiments, the process 1100 may determine a queue depth by accessing a data structure that stores the LAS data packets awaiting transmission.

In some more embodiments, the process 1100 may compare the count of the one or more upstream data packets in the queue with a threshold count (block 1140). The threshold count may refer to a threshold number of upstream data packets, for example, the L4S data packets, set by the access point for detecting a congestion. The process 1100 may determine the threshold count associated with the LAS queue(s). In yet various embodiments, the process 1100 may determine the threshold count based on one or more of: a type of the L4S data packets, priority of the LAS data packets, Quality of Service (QOS) parameters of the L4S data packets, etc. In yet more embodiments, the process 1100 can dynamically change or modify the threshold count based on network conditions, network demand, QoS requirements, etc. In still yet more embodiments, the threshold count may be predetermined for different types of L4S queues defined by access categories including, for example, the BE access category, the VI access category, or the like. In many further embodiments, the threshold count may be configurable by an operator. In many additional embodiments, the threshold count can be different for different LAS data flows associated with different applications implemented by the same wireless device. The process 1100 may continuously or periodically count the number of L4S data packets in the LAS queue(s) and compare this count with the threshold count.

In still yet further embodiments, the process 1100 may determine whether the count of the one or more upstream data packets in the queue exceeds the threshold count (block 1145). The process 1100 may continuously or periodically determine whether the count of the upstream data packets, for example, the LAS data packets in the LAS queue(s) exceeds the threshold count. In still yet additional embodiments, the process 1100 may employ an interrupt-driven mechanism or periodic polling, depending on a design of the access point and management of its resources, to determine whether the count of the L4S data packets in the LAS queue(s) exceeds the threshold count. If the count of the LAS packets in the LAS queue(s) exceeds the threshold count, the process 1100 may execute different actions depending on the specific configuration.

In response to determining the count of the one or more upstream data packets in the queue exceeds the threshold count, in several embodiments, the process 1100 may detect a congestion associated with the upstream LAS data flow (block 1150). In several more embodiments, the process 1100 may detect the congestion at the access point based on the count of the upstream data packets, for example, the LAS data packets, exceeding the threshold count. If the LAS data packets are delayed due to waiting in the queue for a long time, it suggests that the congestion associated with the upstream LAS data flow, herein referred to as “upstream LAS congestion”, is being experienced at the access point. The process 1100 may track and report the count of the L4S data packets waiting in the L4S queue(s) to allow the detection of the upstream LAS congestion.

In numerous embodiments, the process 1100 may identify a downstream LAS data flow, comprising a plurality of downstream data packets, associated with the upstream LAS data flow (block 1160). The downstream LAS data flow may refer to the LAS data packets coming from the network device and flowing in the downstream direction towards the wireless device. In an example, the network device may be an application server. To identify the downstream LAS data flow, in numerous additional embodiments, the process 1100 may receive the downstream L4S data flow from the network device; and determine that the downstream L4S data flow is associated with a source address associated with the network device and a destination address associated with the wireless device. In other words, the process 1100 may determine a downstream LAS data flow associated with a reverse IP tuple, that is, the downstream LAS data flow where the source and destination IP addresses and/or source and destination port numbers may be reversed.

In many embodiments, the process 1100 may mark one or more downstream data packets of the plurality of downstream data packets with a congestion indicator (block 1170). The process 1100 may mark one or more of the downstream LAS data packets having the identified reverse IP tuple, that are flowing in the downstream direction, with the congestion indicator, to indicate to the wireless device that the congestion is experienced in the upstream direction. In a number of embodiments, the congestion indicator may be indicative of the upstream LAS congestion. In a variety of embodiments, the congestion indicator may be marked in one of a Layer 3 header or a higher layer header than the layer 3 header of the one or more downstream data packets to indicate the congestion in the upstream direction. In many further embodiments, the congestion indicator may correspond to one of: one or more bits in an IP Option field of an IP version 4 (IPv4) header, one or more bits in a Flags field in the IPv4 header, or one or more bits in an Extension header in an IP version 6 (IPv6) header. In many more embodiments, the congestion indicator may correspond to a specific value in a DSCP field in an IP header, for example, a DSCP value “63” with all 6 DSCP bits set to 1. Further, to reverse signal the upstream LAS congestion, the process 1100 may mark “01” to denote L4S enabled packets in the ECN field of the header of one or more of the downstream LAS data packets of the downstream data flow. In one or more embodiments, marking of the one or more downstream data packets with the congestion indicator is performed at the higher protocol layer prior to the one or more downstream data packets being queued for transmission at the lower protocol layer.

In various embodiments, the process 1100 may transmit the one or more downstream data packets to the wireless device (block 1180). The marking of ECN=01 and the congestion indicator in the downstream L4S data packets may signal the upstream LAS congestion to the wireless device without causing significant delays. The wireless device may then adjust its transmission rate, for example, reduce the transmission rate, in response to the indicated upstream L4S congestion. The reduction in the transmission rate may reduce the upstream LAS congestion at the access point. In more embodiments, the wireless device may allocate fewer resources based on the indicated upstream L4S congestion.

However, in response to determining the count of the one or more upstream data packets in the queue does not exceed the threshold count, in additional embodiments, the process 1100 may proceed to receive, from the wireless device, an upstream LAS data flow comprising a plurality of upstream data packets (block 1110) and repeat the process 1100. In further embodiments, the count of the upstream data packets in the queue not exceeding the threshold count may indicate there is no upstream LAS congestion. The queue depth or the count of the upstream data packets in the queue being consistently below the threshold count indicates that there is no upstream L4S congestion. When the LAS queue(s) is not overflowing and the number of upstream data packets waiting is within the threshold count, it means the access point can handle the incoming traffic, suggesting no upstream LAS congestion.

Although a specific embodiment for a process 1100 for reverse signaling of upstream congestion suitable for carrying out the various steps, processes, methods, and operations described herein is discussed with respect to FIG. 11, any of a variety of systems and/or processes may be utilized in accordance with embodiments of the disclosure. For example, instead of utilizing ECN=11 as the congestion indicator, other bits utilized for legacy congestion notifications may be utilized for reverse signaling of upstream congestion. The elements depicted in FIG. 11 may also be interchangeable with other elements of FIGS. 1-10 and FIG. 12 as required to realize a particularly desired embodiment.

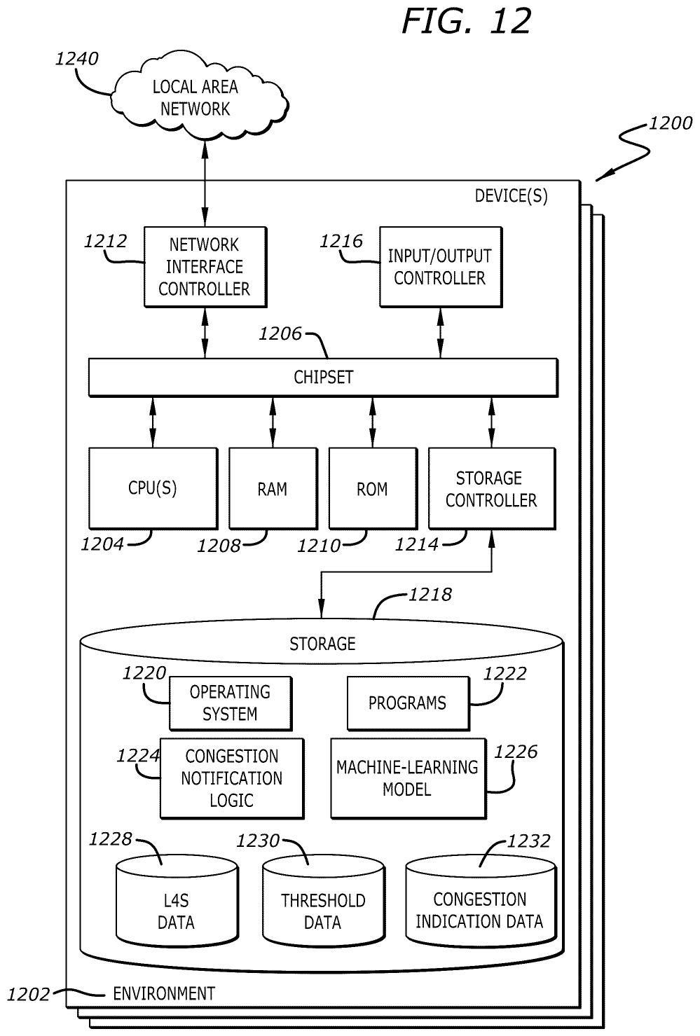

Referring to FIG. 12, a conceptual block diagram of a device 1200 suitable for configuration with a congestion notification logic 1224 for implementing the functionality and various embodiments of the disclosure is shown. The embodiment of the conceptual block diagram depicted in FIG. 12 can illustrate a conventional server computer, a workstation, a desktop computer, a laptop, a tablet, a network appliance, an electronic reader (e-reader), a smartphone, or other computing device, and can be utilized to execute any of the application and/or logic components presented herein. The device 1200 may, in some examples, correspond to a physical device or to a virtual resource described herein. The device 1200 can be a network device (for example, an access point, a switch, a controller, or a destination server), a wireless device such as a client device, or the like in accordance with various embodiments of the disclosure.

In many embodiments, the device 1200 may include an environment 1202 such as a baseboard or a “motherboard,” in physical embodiments that can be configured as a printed circuit board with a multitude of components or devices connected by way of a system bus or other electrical communication paths. Conceptually, in virtualized embodiments, the environment 1202 may be a virtual environment that encompasses and executes the remaining components and resources of the device 1200. In a number of embodiments, one or more processors 1204, such as, but not limited to, central processing units (CPUs) can be configured to operate in conjunction with a chipset 1206. The processor(s) 1204 can be standard programmable CPUs that perform arithmetic and logical operations necessary for the operation of the device 1200.

In a variety of embodiments, the processor(s) 1204 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1206 may provide an interface between the processor(s) 1204 and the remainder of the components and devices within the environment 1202. The chipset 1206 can provide an interface to a random-access memory (RAM) 1208, which can be utilized as the main memory in the device 1200 in some embodiments. The chipset 1206 can further be configured to provide an interface to a computer-readable storage medium such as a read-only memory (ROM) 1210 or a Non-Volatile RAM (NVRAM) for storing basic routines that can help with various tasks such as, but not limited to, starting up the device 1200 and/or transferring information between the various components and devices. The ROM 1210 or NVRAM can also store other application components necessary for the operation of the device 1200 in accordance with various embodiments described herein.

Different embodiments of the device 1200 can be configured to operate in a networked environment using logical connections to remote computing devices and computer systems through a network, such as the network 1240. The chipset 1206 can include functionality for providing network connectivity through a Network Interface Controller (NIC) 1212, which may include a gigabit Ethernet adapter or similar component. The NIC 1212 can be capable of connecting the device 1200 to other devices over the network 1240. It is contemplated that multiple NICs 1212 may be present in the device 1200, connecting the device 1200 to other types of networks and remote systems.

In more embodiments, the device 1200 can be connected to a storage 1218 that provides non-volatile storage for data accessible by the device 1200. The storage 1218 can, for example, store an operating system 1220, applications or programs 1222, L4S data 1228, threshold data 1230, and congestion indication data 1232, which are described in greater detail below. The storage 1218 can be connected to the environment 1202 through a storage controller 1214 connected to the chipset 1206. In additional embodiments, the storage 1218 can include one or more physical storage units. The storage controller 1214 can interface with the physical storage units through a Serial Advanced Technology Attachment (SATA) interface, a Fiber Channel (FC) interface, a Serial Attached SCSI (SAS) interface, where SCSI refers to a Small Computer System Interface, or other type of interface for physically connecting and transferring data between computers and physical storage units.

The device 1200 can store data within the storage 1218 by transforming the physical state of the physical storage units to reflect the information being stored. The specific transformation of physical state can depend on various factors. Examples of such factors can include, but are not limited to, the technology utilized to implement the physical storage units, whether the storage 1218 is characterized as primary or secondary storage, and the like. For example, the device 1200 can store information within the storage 1218 by issuing instructions through the storage controller 1214 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1200 can further read or access information from the storage 1218 by detecting the physical states or characteristics of one or more particular locations within the physical storage units.

In addition to the storage 1218 described above, the device 1200 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1200. In some examples, the operations performed by a cloud computing network, and or any components included therein, may be supported by one or more devices similar to the device 1200. Stated otherwise, some or all of the operations performed by the cloud computing network, and or any components included therein, may be performed by one or more devices 1200 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, Erasable Programmable ROM (EPROM), Electrically-Erasable Programmable ROM (EEPROM), flash memory or other solid-state memory technology, Compact Disc-ROM (CD-ROM), Digital Versatile Disk (DVD), High Definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 1218 can store an operating system 1220 utilized to control the operation of the device 1200. According to one embodiment, the operating system 1220 includes the LINUX operating system. According to another embodiment, the operating system 1220 includes the Windows® server operating system from Microsoft Corporation of Redmond, Washington. According to further embodiments, the operating system 1220 can include the UNIX operating system or one of its variants. It should be appreciated that other operating systems can also be utilized. The storage 1218 can store other system or application programs and data utilized by the device 1200.

In still more embodiments, the storage 1218 or other computer-readable storage media is encoded with computer-executable instructions which, when loaded into the device 1200, may transform the device 1200 from a general-purpose computing system into a special-purpose computer capable of implementing the embodiments described herein. These computer-executable instructions may be stored as applications or programs 1222 and transform the device 1200 by specifying how the processor(s) 1204 can transition between states, as described above. In still further embodiments, the device 1200 has access to computer-readable storage media storing computer-executable instructions which, when executed by the device 1200, perform the various processes described above with regard to FIGS. 1-12. In still additional embodiments, the device 1200 can also include computer-readable storage media having instructions stored thereupon for performing any of the other computer-implemented operations described herein.

In some more embodiments, the device 1200 can also include one or more input/output controllers 1216 for receiving and processing input from a number of input devices, such as a keyboard, a mouse, a touchpad, a touch screen, an electronic stylus, or other type of input device. Similarly, an input/output controller 1216 can be configured to provide output to a display, such as a computer monitor, a flat panel display, a digital projector, a printer, or other type of output device. Those skilled in the art will recognize that the device 1200 may not include all of the components shown in FIG. 12, and can include other components that are not explicitly shown in FIG. 12, or may utilize an architecture completely different than that shown in FIG. 12.

As described above, the device 1200 may support a virtualization layer, such as one or more virtual resources executing on the device 1200. In some examples, the virtualization layer may be supported by a hypervisor that provides one or more virtual machines running on the device 1200 to perform functions described herein. The virtualization layer may generally support a virtual resource that performs at least a portion of the techniques described herein.

In yet various embodiments, the device 1200 can include a congestion notification logic 1224 that may be responsible for reverse signaling of downstream congestion and upstream congestion. In yet more embodiments, the congestion notification logic 1224 may operate in the controller. In embodiments where the device 1200 corresponds to the access point, the congestion notification logic 1224 can be configured to perform various operations such as, but not limited to, receiving, from the network device, a downstream LAS data flow including a plurality of downstream data packets; detecting a congestion associated with the downstream L4S data flow; identifying an upstream LAS data flow, including a plurality of upstream data packets, associated with the downstream L4S data flow; and marking one or more upstream data packets of the plurality of upstream data packets with a congestion indicator. In still yet more embodiments where the device 1200 corresponds to the access point, the congestion notification logic 1224 can be configured to perform various operations such as, but not limited to, receiving, from the wireless device, an upstream LAS data flow including a plurality of upstream data packets; detecting a congestion associated with the upstream LAS data flow; generating a congestion signaling request configured to indicate the detected congestion; and transmitting a congestion indicator to the wireless device based on the generated congestion signaling request. In many further embodiments where the device 1200 corresponds to the access point, the congestion notification logic 1224 can be configured to perform various operations such as, but not limited to, receiving, from the wireless device, an upstream L4S data flow including a plurality of upstream data packets; detecting a congestion associated with the upstream L4S data flow; identifying a downstream L4S data flow, including a plurality of downstream data packets, associated with the upstream L4S data flow; and marking one or more downstream data packets of the plurality of downstream data packets with a congestion indicator.

Those skilled in the art will recognize that the congestion notification logic 1224 can include various hardware and/or software deployments and can be configured in a variety of ways. In many additional embodiments, the congestion notification logic 1224 can be configured as a standalone device, exist as a logic in another network device, be distributed among various network devices operating in tandem, or remotely operated as part of a cloud-based network management tool. In still yet further embodiments, one or more servers can be configured with the congestion notification logic 1224 or can otherwise operate as the congestion notification logic 1224. In still yet additional embodiments, the congestion notification logic 1224 may operate on one or more servers connected to a communication network, for example, the Internet. The communication network can include wired networks or wireless networks. The congestion notification logic 1224 can be provided as a cloud-based service that can service remote networks, such as, but not limited to, a deployed network. Further, in several embodiments, the congestion notification logic 1224 may be operated as a distributed logic across multiple network devices. In an embodiment, the controller can operate as the congestion notification logic 1224 or may have multiple devices operate as the congestion notification logic 1224 in a distributed manner.

In several more embodiments, the storage 1218 can include LAS data 1228. The LAS data 1228 may relate to data representative of data flows, for example, downstream LAS data flows and upstream LAS data flows. For example, the L4S data 1228 may include downstream data packets and upstream data packets included in their respective data flows. In numerous embodiments, the LAS data 1228 may allow identification of the downstream LAS data flows and the upstream L4S data flows for reverse signaling of congestion detected at the access point.

In numerous additional embodiments, the storage 1218 can include threshold data 1230. The threshold data 1230 may relate to data representative of one or more threshold counts associated with one or more downstream LAS queues and upstream LAS queues. In further additional embodiments, the threshold data 1230 may be utilized by the congestion notification logic 1224 to detect the congestion in the downstream LAS data flows and the upstream L4S data flows.

In many embodiments, the storage 1218 can include congestion indication data 1232. The congestion indication data 1232 may relate to data representative of the congestion indicators, the ECN fields, and/or the MPDUs associated with the data flows. For example, the congestion indication data 1232 may include values indicated in congestion indication control fields of the MPDUs, etc. In a number of embodiments, the congestion indication data 1232 may be utilized by the congestion notification logic 1224 to reverse indicate and signal downstream and upstream congestion.

In a variety of embodiments, data may be processed into a format usable by a machine-learning (“ML”) model 1226 (e.g., feature vectors), and or other pre-processing techniques. The ML model 1226 may be any type of ML model, such as supervised models, reinforcement models, and/or unsupervised models. The ML model 1226 may include one or more of linear regression models, logistic regression models, decision trees, Naïve Bayes models, neural networks, k-means cluster models, random forest models, and/or other types of ML models. The ML model 1226 may be configured to analyze the L4S data 1228, the threshold data 1230, and the congestion indication data 1232 for reverse signaling of downstream congestion and upstream congestion. In various embodiments, the ML model 1226 may be utilized to identify various parameters to include in the LAS data 1228, the threshold data 1230, and the congestion indication data 1232. For example, the ML model 1226 may analyze the L4S data 1228, the threshold data 1230, and the congestion indication data 1232 and identify parameters that are required to augment the L4S data 1228, the threshold data 1230, and the congestion indication data 1232. Once the parameters are identified, the congestion notification logic 1224 may utilize the parameters to perform reverse signaling of downstream congestion and upstream congestion. For example, the ML model 1226 may be configured to receive the L4S data 1228, the threshold data 1230, and the congestion indication data 1232. The congestion notification logic 1224 may then utilize trained models to reverse signal downstream congestion and upstream congestion.

Although a specific embodiment for a device 1200 suitable for configuration with the congestion notification logic 1224 for carrying out the various steps, processes, methods, and operations described herein is discussed with respect to FIG. 12, any of a variety of systems and/or processes may be utilized in accordance with embodiments of the disclosure. For example, the device may be implemented in a virtual environment such as a cloud-based network administration suite or a cloud computing environment, or the device may be distributed across a variety of network devices such that each acts as a device and the congestion notification logic 1224 acts in tandem between the devices. The elements depicted in FIG. 12 may also be interchangeable with other elements of FIGS. 1-11 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous,” “exemplary,” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
a congestion notification logic configured to:
receive, from a network device, a downstream Low Latency, Low Loss, and Scalable throughput (L4S) data flow comprising a plurality of downstream data packets;
detect a congestion associated with the downstream LAS data flow;
identify an upstream L4S data flow, comprising a plurality of upstream data packets, associated with the downstream LAS data flow; and
mark one or more upstream data packets of the plurality of upstream data packets with a congestion indicator.

2. The device of claim 1, wherein the congestion indicator is indicative of the congestion associated with the downstream L4S data flow.

3. The device of claim 1, wherein the downstream LAS data flow is indicative of a first source address associated with the network device and a first destination address associated with a wireless device.

4. The device of claim 3, wherein identifying the upstream L4S data flow that is associated with the downstream L4S data flow comprises:
receiving one or more upstream L4S data flows from the wireless device; and
determining that the upstream LAS data flow of the one or more upstream LAS data flows is associated with a second source address associated with the wireless device and a second destination address associated with the network device.

5. The device of claim 1, wherein the congestion notification logic is further configured to transmit the one or more upstream data packets marked with the congestion indicator to the network device.

6. The device of claim 1, wherein the congestion indicator is marked in one of a Layer 3 header or a higher layer header than the Layer 3 header of each of the one or more upstream data packets to indicate the congestion in a downstream direction.

7. The device of claim 6, wherein the congestion indicator corresponds to one of:
one or more bits in an Internet Protocol (IP) Option field of an IP version 4 (IPv4) header,
one or more bits in a Flags field in the IPv4 header,
one or more bits in an Extension header in an IP version 6 (IPv6) header, or
a specific value in a Differentiated Services Code Point (DSCP) field in an IP header.

8. The device of claim 1, wherein detecting the congestion associated with the downstream L4S data flow comprises:
storing one or more downstream data packets of the plurality of downstream data packets in a queue;
determining a count of the one or more downstream data packets in the queue; and
comparing the count of the one or more downstream data packets with a threshold count, wherein the congestion is detected based on the count of the one or more downstream data packets exceeding the threshold count.

9. A device, comprising:
a processor;
a memory communicatively coupled to the processor; and
a congestion notification logic configured to:
receive, from a wireless device, an upstream Low Latency, Low Loss, and Scalable throughput (LAS) data flow comprising a plurality of upstream data packets;
detect a congestion associated with the upstream L4S data flow;
generate a congestion signaling request configured to indicate the detected congestion; and
transmit a congestion indicator to the wireless device based on the generated congestion signaling request.

10. The device of claim 9, wherein the congestion indicator is indicative of the congestion associated with the upstream LAS data flow.

11. The device of claim 9, wherein transmitting the congestion indicator comprises:
generating a Media Access Control (MAC) Protocol Data Unit (MPDU) comprising a congestion indication control field in a MAC header; and
transmitting the MPDU to the wireless device.

12. The device of claim 11, wherein the congestion indication control field comprises a value indicative of the congestion associated with the upstream LAS data flow.

13. The device of claim 9, wherein the congestion signaling request comprises at least one of:
a priority of one or more upstream data packets of the plurality of upstream data packets associated with the congestion in the upstream L4S data flow,
an identifier of the upstream L4S data flow,
an indication of a direction of the detected congestion,
a count of the one or more upstream data packets,
a percentage of upstream data packets of the upstream LAS data flow experiencing the detected congestion, or
a probability of the congestion being experienced by the one or more upstream data packets.

14. The device of claim 9, wherein the congestion indicator is transmitted to the wireless device in at least one of a downstream data packet having the wireless device as a destination, a quality of service null frame, or a management frame.

15. The device of claim 14, wherein the management frame comprises at least one of:
a priority of one or more upstream data packets of the plurality of upstream data packets associated with the congestion in the upstream L4S data flow,
an identifier of the one or more upstream data packets,
an indication of a direction of the detected congestion,
a count of the one or more upstream data packets,
a percentage of upstream data packets of the upstream LAS data flow experiencing the detected congestion, or
a probability of the congestion being experienced by the one or more upstream data packets.

16. The device of claim 9, wherein detecting the congestion associated with the upstream LAS data flow comprises:
storing one or more upstream data packets of the plurality of upstream data packets in a queue;
determining a count of the one or more upstream data packets in the queue; and
comparing the count of the one or more upstream data packets with a threshold count, wherein the congestion is detected based on the count of the one or more upstream data packets exceeding the threshold count.

17. The device of claim 9, wherein the upstream LAS data flow is indicative of a source address associated with the wireless device and a destination address associated with a network device.

18. A device, comprising:
a processor;
a memory communicatively coupled to the processor; and
a congestion notification logic configured to:
receive, from a wireless device, one or more upstream Low Latency, Low Loss, and Scalable throughput (LAS) data flows;
detect a congestion associated with an upstream LAS data flow of the one or more upstream L4S data flows;
identify a downstream L4S data flow, comprising a plurality of downstream data packets, associated with the upstream LAS data flow; and
mark one or more downstream data packets of the plurality of downstream data packets with a congestion indicator.

19. The device of claim 18, wherein the congestion indicator is indicative of the congestion associated with the upstream L4S data flow.

20. The device of claim 18, wherein identifying the downstream LAS data flow associated with the upstream LAS data flow comprises:
receiving the downstream LAS data flow from the device; and
determining that the downstream LAS data flow is associated with a source address associated with the device and a destination address associated with the wireless device.
